(19) United States
(12) Patent Application Publication
(10) Pub. No.: US 2024/0090495 A1
(43) Pub. Date: Mar. 21, 2024

(54) APPARATUS, SYSTEM, AND METHOD FOR ORGAN PERFUSION

(71) Applicant: Daris LLC, Ann Harbor, MI (US)

(72) Inventor: Daniel E. MAZUR, Ann Harbor, MI (US)

(21) Appl. No.: 18/370,688

(22) Filed: Sep. 20, 2023

Related U.S. Application Data
(60) Provisional application No. 63/408,805, filed on Sep. 21, 2022.
(60) Provisional application No. 63/408,838, filed on Sep. 21, 2022.

(51) Int. Cl. A01N 1/02

(52) U.S. Cl. CPC A01N 1/0247; A01N 1/0226

(57) ABSTRACT

The invention relates to a perfusion and liquor change system for an isolated organ. The system comprises a pipeline power circulation subsystem, a liquor change subsystem and a control subsystem, wherein the pipeline power circulation subsystem is in through connection with an isolated organ perfusion system; the liquor change subsystem is in through connection with the pipeline power circulation subsystem; the control subsystem is independently in communication connection with the pipeline power circulation subsystem and the liquor change subsystem; the liquor change subsystem is used for obtaining and filtering the perfusion liquor of the isolated organ perfusion system and is also used for transmitting replenishing liquor and the filtered perfusion liquor to the isolated organ perfusion system through the pipeline power circulation subsystem; and the control subsystem is used for obtaining waste liquor generation data in preset time, obtaining the replenishing data of the replenishing liquor according to the waste liquor generation data, and driving the liquor change subsystem to transmit the replenishing liquor to the pipeline power circulation subsystem according to the replenishing data. By use of the system, the perfusion and liquor change balance of the system can be realized, an operation process of the liquor change of the perfusion liquor is simplified, a liquor change error is reduced, liquor change accuracy is improved, and meanwhile, secondary pollution in a liquor change process can be avoided.

### CROSS-REFERENCE TO RELATED APPLICATIONS

This application claims the benefit of U.S. Provisional Application No. 63/408,805, filed Sep. 21, 2022, entitled “Method for Rapid and Accurate Determination of Average Fluid Circuit Pressure and Flowrate Produced by Roller Pump”, and U.S. Provisional Application No. 63/408,838, filed Sep. 21, 2022, entitled “Automatic Perfusion System Configurable for Ex-Vivo Perfusion of Multiple Organ Types and Whole Body Perfusion” which are hereby incorporated by reference in their entireties.

### TECHNICAL FIELD

The present disclosure relates to apparatuses, systems, and methods relating to perfusion of an organ or other body part of an animal or human. More specifically, the present disclosure relates to apparatuses, systems, and methods for perfusion with extended sustainability of the organ(s) and/or body part.

### BACKGROUND

Organ perfusion has a variety of benefits for medical science and patients. Organ perfusion can be used to assess, resuscitate, preserve, treat, and/or rehabilitate donated organs for use in medical research, patient treatments, and/or transplantation into recipients.

One of the challenges with conventional perfusion apparatuses, systems, methods, and/or techniques is how to perfuse the organ, tissue, and/or body part in a way that provides for extended viability of the organ, tissue, and/or body part. Conventional perfusion apparatuses, systems, methods, and/or techniques are limited to maintaining viability of the organ, tissue, and/or body part to a few hours (about 12 hours). Furthermore, conventional perfusion techniques and/or systems require an operator to constantly monitor and adjust parameters for the various components and stages in order to maintain a viable organ, tissue, and/or body part. In addition, conventional perfusion techniques and/or systems include a number of control loops with operating parameters that can be complex and difficult to manage and react to changes in the control loops in order to maintain successful perfusion of the organ, tissue, and/or body part. Another obstacle with conventional perfusion is that management and operation of the perfusion process can introduce delays, interruptions, and/or stoppages of the perfusion process which can negatively impact the perfused organ, tissue, and/or body part such that the organ, tissue, and/or body part becomes unviable.

What is needed is an apparatus, system, and/or method for perfusion that maintains viability for a perfused organ, tissue, and/or body part for a period of time greater than twelve hours. What is needed is an apparatus, system, and/or method for perfusion that reliably offloads the responsibilities of an operator for managing and operating the perfusion apparatus, system, and/or method. What is needed is an apparatus, system, and/or method for perfusion that reliably and automatically adjusts to changes in the conditions of the perfusion to maintain long term viability of the perfused organ, tissue, and/or body part. What is needed is an apparatus, system, and/or method for perfusion that enables reliable and consistent providing of perfusate conditioned for long term perfusion of the perfused organ, tissue, and/or body part. What is needed is an apparatus, system, and/or method for perfusion that enables reliable and consistent providing of perfusate conditioned for long term perfusion of the perfused organ, tissue, and/or body part without disrupting the perfusion. Existing solutions for organ perfusion are inadequate and error prone.

### SUMMARY

The various apparatus, devices, systems, and/or methods of the present disclosure have been developed in response to the present state of the art, and in particular, in response to the problems and needs in the art that have not yet been fully solved by currently available technology.

Some implementations herein relate to a system. For example, the system may include an organ chamber configured to house an organ. A system may also include a fluid circuit having: tubing that couples to the organ within the organ chamber and carries a perfusate to and from the organ; a pump coupled to the tubing, the pump configured to drive the perfusate through the fluid circuit; a replaceable reservoir that supplies perfusate to the tubing for use in the fluid circuit; an oxygenator coupled to the tubing and configured to exchange oxygen gas with waste gas in the perfusate; a hemofilter coupled to the tubing and configured to remove an ultrafiltrate having metabolic waste from the perfusate; a filtrate replacement fluid coupled to the fluid circuit and configured to supply filtrate replacement fluid to the perfusate. A system may furthermore include a controller coupled to the fluid circuit, the controller configured to manage a plurality of perfusion parameters of the fluid circuit to perfuse the organ. Other embodiments of this aspect include corresponding computer systems, apparatus, and computer programs recorded on one or more computer storage devices, each configured to perform the actions of the methods and/or systems.

The described implementations may also include one or more of the following features. A system where the replaceable reservoir is configured to supply clean perfusate without interrupting perfusion of the organ. A system where the replaceable reservoir may include a first filter, a second filter, and a diverter that when activated redirects at least a portion of the perfusate from the first filter to the second filter. A system where the replaceable reservoir may include: a first supply reservoir configured to be coupled to the fluid circuit; a second supply reservoir configured to be coupled to the fluid circuit; and a bulk perfusate diversion system configured to exchange perfusate in the first supply reservoir with perfusate in the second supply reservoir for a bulk removal of metabolic waste in the perfusate. A system may include: a user interface configured to display information to an operator and accept input data from the operator for perfusion parameters for manual operation mode of at least one control loop of a plurality of control loops of the system; and where the controller is configured to transition the at least one control loop from manual operation mode to automated operation mode in response to user input from the operator. A system where the controller is configured to operate the at least one control loop in automated operation mode while another one of the plurality of control loops operates in manual operation mode. A system where the controller modulates the plurality of perfusion parameters of the fluid circuit to perfuse the organ based on a perfusion protocol. A system where the organ is a heart and the perfusion protocol is selected from the group having Langendorff Perfusion, Partial Working Mode Perfusion, Left Atrial Perfusion, and Working Mode Perfusion. A system where the controller modulates a rate of at least one of filtrate replacement fluid supplied to the perfusate and ultrafiltrate removal based on a measured parameter of at least one of the organ and the fluid circuit. Implementations of the described techniques may include hardware, a method or process, or a computer tangible medium.

Some implementations herein relate to a system. For example, a system may include an organ chamber configured to house an organ. A system may also include an extracorporeal fluid circuit having: tubing that couples to the organ within the organ chamber and carries a perfusate to and from the organ; a pump that drives the perfusate through the extracorporeal fluid circuit; an oxygenator coupled to the tubing and configured to exchange oxygen gas with waste gas in the perfusate; perfusate supply that supplies revitalized perfusate to the extracorporeal fluid circuit by way of the tubing. A system may furthermore include a controller coupled to the extracorporeal fluid circuit, the controller configured to manage a plurality of perfusion parameters of the extracorporeal fluid circuit to perfuse the organ. Other embodiments of this aspect include corresponding computer systems, apparatus, and computer programs recorded on one or more computer storage devices, each configured to perform the actions of the methods.

The described implementations may also include one or more of the following features. A system where the perfusate supply may include: at least one inlet port coupled to the tubing; a filter diversion system coupled to the at least one inlet port in fluid communication with the tubing; a first blood filter coupled to the filter diversion system by way of a first filter cap, the first blood filter having a first replaceable filter media; a second blood filter coupled to the filter diversion system by way of a second filter cap, the second blood filter having a second replaceable filter media; and where activation of the filter diversion system diverts the perfusate from the first blood filter to the second blood filter such that replacement of the first replaceable filter media does not interrupt filtration of the perfusate. A system where the filter diversion system may include a filter diverter configured to operate as at least one of a sequential diversion system and parallel diversion system between the first blood filter and the second blood filter. A system where the perfusate supply may include: a first reservoir having a first reservoir inlet port and a first reservoir outlet port; a second reservoir having a second reservoir inlet port and a second reservoir outlet port; a flow diversion system in fluid communication with the first reservoir, the second reservoir, and the tubing. A system where the flow diversion system may include: an inlet diverter in fluid communication with the tubing, with the first reservoir inlet port and with the second reservoir inlet port, the inlet diverter configured to direct the perfusate into the first reservoir; an outlet diverter in fluid communication with the first reservoir outlet port, the second reservoir outlet port, and the tubing, the outlet diverter configured to direct the perfusate from the first reservoir into the extracorporeal fluid circuit; and where activation of the inlet diverter redirects the perfusate from the first reservoir inlet port to the second reservoir inlet port and activation of the outlet diverter redirects the perfusate from the first reservoir outlet port to the second reservoir outlet port such that perfusate of the first reservoir is exchanged in the extracorporeal fluid circuit with the perfusate of the second reservoir. Implementations of the described techniques may include hardware, a method or process, or a computer tangible medium.

Some implementations herein relate to a system. For example, a system may include an organ chamber configured to house an organ. A system may also include a fluid circuit having tubing that couples to the organ within the organ chamber and carries a perfusate to and from the organ; a perfusate supply coupled to the tubing, the perfusate supply configured to provide continuously refreshed perfusate to the fluid circuit; a pump coupled to the tubing, the pump configured to drive the perfusate through the fluid circuit. A system may furthermore include a control system coupled to the fluid circuit, the control system configured to adjust at least one perfusion parameter for the fluid circuit in response to a characteristic of one of the fluid circuit and the organ, control system having: a controller configured to execute executable code to manage perfusion of the organ; a memory having code executable by the controller to manage perfusion of the organ; a communication interface configured to send one or more control signals and receive one or more data signals for managing the fluid circuit; an I/O interface configured to interact with an operator; storage configured to store at least one perfusion protocol predefined for perfusion of the organ; a plurality of sensors configured to detect an attribute regarding at least one aspect of the fluid circuit or the organ; and a plurality of actuators configured to implement a change indicated by the one or more control signals. Other embodiments of this aspect include corresponding computer systems, apparatus, and computer programs recorded on one or more computer storage devices, each configured to perform the actions of the methods.

The described implementations may also include one or more of the following features. A system where the control system may include a set of control system parameters and the controller is configured to change at least one value for the set of control system parameters in response to user input. A system where the at least one perfusion protocol is specific to the organ perfused by the system and the organ is selected from the group having of a heart, a liver, a kidney, a brain, a lung, a stomach, pancreas, an intestine, an arm, a hand, a leg, a foot, and skin. A system where the organ chamber is configured to house a plurality of organs, the fluid circuit couples to the plurality of organs and the control system adjusts the at least one perfusion parameter in response to a characteristic of one of the fluid circuit and the plurality of organs. A system where the control system monitors the fluid circuit and directs the perfusate supply to increase a rate of removing metabolic waste from the perfusate in response to a characteristic satisfying a threshold. A system where the perfusate supply may include: a perfusate filtration system; a perfusate hemofiltration system; and a perfusate supply exchange system; and where the perfusate filtration system, perfusate hemofiltration system, and perfusate supply exchange system are each configured to refresh perfusate without interrupting perfusion of the organ. Implementations of the described techniques may include hardware, a method or process, and/or a computer tangible medium.

### BRIEF DESCRIPTION OF THE DRAWINGS

The advantages, nature, and additional features of exemplary embodiments of the disclosure will become more fully apparent from the following description and appended claims, taken in conjunction with the accompanying drawings. Understanding that these drawings depict only exemplary embodiments and are, therefore, not to be considered limiting of the disclosure's scope, the exemplary embodiments of the disclosure will be described with additional specificity and detail through use of the accompanying drawings.

FIG. 1 is a block diagram depicting an exemplary system for perfusing at least one organ, according to one embodiment.

FIG. 2A is a block diagram depicting control loops for exemplary system for perfusing an organ, according to one embodiment.

FIG. 2B is a block diagram depicting example control loops for an exemplary system for perfusing a heart, according to one embodiment.

FIG. 3 is a block diagram depicting an exemplary diversion system for diverting a fluid, according to one embodiment.

FIG. 4 is a block diagram depicting an exemplary diversion system for diverting a fluid, according to one embodiment.

FIG. 5 is a block diagram depicting an exemplary diversion system for diverting a fluid, according to one embodiment.

FIG. 6A illustrates an exemplary system for diverting a fluid flow, according to one embodiment.

FIG. 6B illustrates one example embodiment of a diverter, according to one embodiment.

FIG. 7A illustrates an exemplary apparatus for diverting a fluid flow, according to one embodiment.

FIG. 7B illustrates a perspective view of a filter system of FIG. 7A, according to one embodiment.

FIG. 8 illustrates an exemplary system for perfusing an organ, according to one embodiment.

FIG. 9 illustrates an exemplary system for perfusing an organ, according to one embodiment.

FIG. 10 is a flowchart diagram depicting a method for perfusion, according to one embodiment.

### DETAILED DESCRIPTION

Exemplary embodiments of the disclosure will be best understood by reference to the drawings, wherein like parts are designated by like numerals throughout. It will be readily understood that the components, as generally described and illustrated in the Figures herein, could be arranged and designed in a wide variety of different configurations. Thus, the following more detailed description of the embodiments of the apparatus, system, and method is not intended to limit the scope of the disclosure but is merely representative of exemplary embodiments.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together. The phrase “fluid communication” refers to two features that are connected such that a fluid within one feature can pass into the other feature.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Standard medical planes of reference and descriptive terminology may be employed in this disclosure. While these terms are commonly used to refer to the human body, certain terms are applicable to animals, or to physical objects in general. A standard system of three mutually perpendicular reference planes is employed. A sagittal plane divides a body into right and left portions. A coronal plane divides a body into anterior and posterior portions. A transverse plane divides a body into superior and inferior portions. A mid-sagittal, mid-coronal, or mid-transverse plane divides a body into equal portions, which may be bilaterally symmetric. The intersection of the sagittal and coronal planes defines a superior-inferior or cephalad-caudal axis. The intersection of the sagittal and transverse planes defines an anterior-posterior axis. The intersection of the coronal and transverse planes defines a medial-lateral axis. The superior-inferior or cephalad-caudal axis, the anterior-posterior axis, and the medial-lateral axis are mutually perpendicular.

Anterior means toward the front of a body. Posterior means toward the back of a body. Superior or cephalad means toward the head. Inferior or caudal means toward the feet or tail. Medial means toward the midline of a body, particularly toward a plane of bilateral symmetry of the body. Lateral means away from the midline of a body or away from a plane of bilateral symmetry of the body. Axial means toward a central axis of a body. Abaxial means away from a central axis of a body. Ipsilateral means on the same side of the body. Contralateral means on the opposite side of the body from the side which has a particular condition or structure. Proximal means toward the trunk of the body. Proximal may also mean toward a user, viewer, or operator. Distal means away from the trunk. Distal may also mean away from a user, viewer, or operator. Dorsal means toward the top of the foot or other body structure. Plantar means toward the sole of the foot or toward the bottom of the body structure.

Antegrade means forward moving from a proximal location/position to a distal location/position or moving in a forward direction. Retrograde means backward moving from a distal location/position to a proximal location/position or moving in a backwards direction. Sagittal refers to a midline of a patient's anatomy, which divides the body into left or right halves. The sagittal plane may be in the center of the body, splitting it into two halves. Prone means a body of a person lying face down. Supine means a body of a person lying face up.

“Configuration” refers to an arrangement, setup, design, organization, or values of one or more parts, features, settings, components, aspects, structures, or the like as a module, component, apparatus, device, system, framework, platform, dashboard, assembly, or the like. Examples of configurations can include how dials are setup on a dashboard, levers are set on a control board, switches are set within a controller, bones are arranged within a hand, foot, or limb, or the like.

“Feedback” refers to a reactionary response to an action, a product, service, or task. (Search “feedback” on wordhippo.com. WordHippo, 2023. Web. Modified. Accessed 28 Aug. 2023.) “Haptic” refers to a signal, feeling, or action that a user or receiver can feel using their sense of touch. Thus, haptic feedback is a kind of feedback that a user can feel or detect using their sense of touch.

“Appendage” refers to a projecting part of a structure or living organism, with a distinct appearance and/or function. (Search “appendage” on wordhippo.com. WordHippo, 2023. Web. Modified. Accessed 28 Aug. 2023.) Examples of appendages include fingers, toes, arms, legs, tails, and the like. Examples of an appendage can include a structure of an object or instrument that emulate or have a similar function to similar structures on a person or animal.

“Leg” refers to an appendage of a human or animal that connects a foot to a hip or trunk of a body. A leg can also refer to a part or portion of another structure. Often, a leg can be a narrow, elongated structure resembling a leg of a human.

“Interconnect” refers to a structure configured to join at least two other structures. In one embodiment, the interconnect may be a mechanical structure that may physically connect one structure to another structure. In other embodiments, an interconnect may be embodied as a fastener that enables permanent or temporary joining of one structure to another structure. In still other embodiments, an interconnect may be embodied as a joint or hinge configured to enable one or both structured joined by the interconnect to move relative to each other while remaining joined. In one embodiment, the interconnect may be configured to convey fluid and/or an electric signal between the at least two other structures. For example, the interconnect may comprise a channel or tube configured to convey air between a first opening and a second opening in the channel or tube. Examples of an interconnect include, but are not limited to, a pipe, a tunnel, a chamber a channel, or the like.

“Anatomical structure” refers to any part or portion of a part of a body of a person, animal, or other patient. Examples of anatomical structures, include but are not limited to, a bone, bones, soft tissue, a joint, joints, a tissue surface, a protrusion, a recess, an opening, skin, hard tissue, teeth, mouth, eyes, hair, nails, fingers, toes, legs, arms, torso, vertebrae, ligaments, tendons, organs, or the like.

As used herein, a “condition” refers to a state of something with regard to its appearance, quality, or working order. In certain aspects, a condition may refer to a patient's state of health or physical fitness or the state of health or physical fitness of an organ or anatomical part of a patient. In certain embodiments, a condition may refer to an illness, pain, discomfort, defect, disease, or deformity of a patient or of an organ or anatomical part of a patient. (Search “condition” on wordhippo.com. WordHippo, 2021. Web. Accessed 8 Dec. 2021. Modified.)

As used herein, an “opening” refers to a gap, a hole, an aperture, a port, a portal, a slit, a space or recess in a structure, a void in a structure, or the like. In certain embodiments, an opening can refer to a structure configured specifically for receiving something and/or for allowing access. In certain embodiments, an opening can pass through a structure. In such embodiments, the opening can be referred to as a window. In other embodiments, an opening can exist within a structure but not pass through the structure. In other embodiments, an opening can initiate on a surface or at an edge or at a side of a structure and extend into the structure for a distance, but not pass through or extend to another side or edge of the structure. In other embodiments, an opening can initiate on a surface or at an edge or at a side of a structure and extend into the structure until the opening extends through or extends to another side or edge of the structure. An opening can be two-dimensional or three-dimensional and can have a variety of geometric shapes and/or cross-sectional shapes, including, but not limited to a rectangle, a square, or other polygon, as well as a circle, an ellipse, an ovoid, or other circular or semi-circular shape. As used herein, the term “opening” can include one or more modifiers that define specific types of “openings” based on the purpose, function, operation, position, or location of the “opening.” As one example, a “fastener opening” refers to an “opening” adapted, configured, designed, or engineered to accept or accommodate a “fastener.”

As used herein, an “interface,” “user interface,” or “engagement interface” refers to an area, a boundary, or a place at which two separate and/or independent structures, members, apparatus, assemblies, components, and/or systems join, connect, are coupled, or meet and act on, or communicate, mechanically and/or electronically, with each other. In certain embodiments, “interface” may refer to a surface forming a common boundary of two bodies, spaces, structures, members, apparatus, assemblies, components, or phases. (search “interface” on Merriam-Webster.com. Merriam-Webster, 2021. Web. 15 Nov. 2021. Modified.) In certain embodiments, “Interface” can refer to a protocol and associated circuits, circuitry, components, devices, structures, apparatuses, systems, sub-systems, and the like that enable one device, component, or apparatus to interact and/or communicate with another device, component, user, or apparatus.

In certain embodiments, the term interface may be used with an adjective that identifies a type or function for the interface. For example, an engagement or coupling interface may refer to one or more structures that interact, connect, or couple to mechanically join or connect two separate structures, each connected to a side of the interface. In another example, a user interface may refer to one or more mechanical, electrical, or electromechanical structures that interact with or enable a user to provide user input, instructions, input signals, data, or data values and receive output, output data, or feedback.

As used herein, a “drive” refers to an apparatus, instrument, structure, device, component, system, or assembly structured, organized, configured, designed, arranged, or engineered to receive a torque and transfer that torque to a structure connected or coupled to the drive. At a minimum, a drive is a set of shaped cavities and/or protrusions on a structure that allows torque to be applied to the structure. Often, a drive includes a mating tool, known as a driver. For example, cavities and/or protrusions on a head of a screw are on kind of drive and an example of a corresponding mating tool is a screwdriver, that is used to turn the screw, the drive. Examples of a drive include, but are not limited to, screw drives such as slotted drives, cruciform drives, square drives, multiple square drives, internal polygon, internal hex drives, pentalobular sockets, hexalobular sockets, combination drives, external drives, tamper-resistant drives, motors, pumps, fluid pumps, and the like. (Search ‘list of screw drives’ on Wikipedia.com Mar. 12, 2021. Modified. Accessed Mar. 19, 2021.)

“Perfusion” refers to an act of forcing a fluid to flow or driving a fluid over or through something, especially through an organ, tissue, or other part of the body of a human or animal. (Search “perfuse” on wordhippo.com. WordHippo, 2023. Web. Modified. Accessed 30 Aug. 2023.) Often, the fluid used in perfusion is blood, a blood-based product, and/or a blood substitute.

“Organ” refers to a distinct anatomical structure composed of specialized tissues that perform specific functions within an organism's body. Organs are essential components of living organisms, ranging from simple organisms to complex multicellular organisms including animals and humans. Organs cooperate to support the overall function of an organism and maintain its physiological processes. (© ChatGPT August 3 Version, Modified, accessed chat.openai.com/chat Aug. 30, 2023). Examples of an organ include tissue and body parts, including arms, hands, feet, legs, fingers, toes and include organs such as a heart, a brain, a kidney, a lung, a pancreas, a stomach, an intestine, a liver, and the like.

“Organ Chamber” refers to any apparatus, instrument, structure, device, component, system, or assembly structured, organized, configured, designed, arranged, or engineered to hold, support, retain, house, enclose, or contain one or more organs. An organ chamber can include a base and a cover, dome, lid, or door, and/or one or more access ports or openings to permit access to the organ by tubing, hoses, probes, wires, conduit, instruments, or the like. In certain embodiments, an organ chamber may be made of plastic or glass and may be reusable or disposable. In certain embodiments, an organ chamber can be implemented as a flexible sac arranged to hold and support the organ. The organ chamber may also include or may be filled with fluid. When implemented as a flexible sac or a structure that includes fluid, this can allows ultrasonic evaluation of the organ and its anatomical structure.

“Filter” refers to a structure, device, apparatus, member, component, system, assembly, module, or subsystem that is organized, configured, designed, arranged, or engineered to remove, trap, collect, gather, select between, or prevent passage of one or more elements traveling in, or suspended within, a fluid. In certain embodiments, a filter may be organized, configured, designed, arranged, or engineered for use over the lifetime of a user or operator or of a system that incorporates the filter. In other embodiments, a filter may be organized, configured, designed, arranged, or engineered to provide effective service for a certain number of uses and/or amount of fluid flow past or through the filter. After these limits are met, the filter may be replaced to restore effective filtration. In certain embodiments, a filter can include a defoamer that serves to mitigate, prevent creation of, and/or buildup of bubbles in a fluid. Alternatively, or in addition, a filter can function as both a filter and a defoamer. In another embodiment, a defoamer may be a structure, device, apparatus, member, component, system, assembly, module, or subsystem separate from a filter.

“Hemofilter”, “hemodialyzers”, or “dialysis filters” refers to a structure, device, instrument, apparatus, system, implant, or the like, that is organized, configured, designed, engineered, and/or arranged to serve a filtering function in a hemofiltration process or method. In certain embodiments, a hemofilter can include a housing and a semipermeable membrane that allows selective passage of substances while retaining blood cells and larger molecules. A variety of biocompatible and effective filtration materials can be used. Examples of such materials include, but are not limited to for the semipermeable membrane materials such as Polysulfone, Polyethersulfone, and/or Cellulose Acetate can be used. For the housing, ports, connectors, and conduit, medical-grade plastics, metal, ceramics, metal alloys, and/or composites can be used. The choice of materials in a hemofilter can be selected to minimize a risk of blood clot formation, mitigate activation of blood clotting factors, and/or mitigate immune responses during blood filtration. (© ChatGPT August 3 Version, Modified, accessed chat.openai.com/chat Aug. 31, 2023).

“Hemofiltration” refers to a process, method, procedure that filters and cleanses blood (or a blood substitute such as a perfusate) by removing excess fluid, waste products, and electrolytes from the bloodstream. Hemofiltration can be considered a form of renal replacement therapy. In one embodiment of hemofiltration, the blood (or a blood substitute such as a perfusate) passes through a semipermeable membrane, which allows a fluid of water, electrolytes, and small molecules (including waste products) to pass through while retaining larger blood cells and proteins. This fluid that passes through the membrane, along with waste products and excess electrolytes, can be referred to as an ultrafiltrate or simply filtrate.

The ultrafiltrate can be collected and discarded to effectively remove excess fluid from the bloodstream/blood circuit. To prevent excessive removal of fluid and/or certain electrolytes, drugs, and/or nutrients, a replacement fluid, referred to herein as a filtrate replacement fluid (FRF) or ultrafiltrate replacement fluid (UFRF) together with, or without, drugs and/or nutrients, can be infused back into the bloodstream/blood circuit. This helps maintain a desired composition in the bloodstream/blood circuit. In hemofiltration, a portion of the blood (or a blood substitute such as a perfusate) that does not pass through the membrane and remains on the intake or input side of the membrane is referred to as a retentate. Retentate can include water, blood cells, proteins, and larger solutes. (© ChatGPT August 3 Version, Modified, accessed chat.openai.com/chat Aug. 31, 2023).

“Ultrafilter” refers to a dense filter used for the filtration of a colloidal solution that holds back the dispersed particles but not the liquid. “Ultrafilter.” Merriam-Webster.com Medical Dictionary, Merriam-Webster, www.merriam-webster.com/medical/ultrafilter. Accessed 31 Aug. 2023.

“Data signal” refers to an electrical signal (wired or wireless) sent from one component, circuit, driver, device, manager, or controller to another component, circuit, driver, device, manager, or controller. In particular, a data signal is a signal configured to represent a data value. A data signal may be contrasted with a control signal configured to cause another device, component, manager, or controller to act in response to the control signal.

“Donor” refers to an animal or human from which an organ is harvested that is to be used in an Ex Vivo perfusion system.

“Recipient” refers to an animal or human into which a harvested organ is to be transplanted.

“Oxygenator” refers to any structure, apparatus, surface, device, system, feature, or aspect configured for use in extracorporeal circulation systems, such as normothermic ex-vivo perfusion system. An oxygenator's primary function is to exchange oxygen and carbon dioxide with the patient's blood, a perfusion fluid, and/or a perfusate. (© ChatGPT August 3 Version, Modified, accessed chat.openai.com/chat Aug. 30, 2023). In one embodiment, an oxygenator can be configured to exchange gases in order to maintain a target level of oxygen (O2) content and target carbon dioxide (CO2) level (or pH) of a perfusate for a perfusion operation. In certain embodiments, an oxygenator may include functionality to heat or cool a fluid supplied to the oxygenator. Consequently, the oxygenator may include a heater and/or a cooler. In one implementation, an oxygenator may have a hollow fiber membrane section or metallic tubes in contact with blood or perfusate that carry circulated temperature controlled water that is provided by a heater/cooler in order to transfer thermal energy to or from the blood or perfusate.

“Normothermic Ex Vivo Perfusion” (NEVP) or “Normothermic perfusion” refers to a form of perfusion involving an organ outside a body of a human or animal that is perfused at a temperate at or about a normal temperature the organ experiences when functioning within a human or animal. NEVP can also include temperatures slightly lower than normal which is subnormothermic. In example implementations a NEVP system or apparatus can include settings for temperatures in the following ranges: Hypothermic about +4 C degrees to about +10 C degrees; Subnormothermic about 15 C degrees to about 30 C degrees; Normothermic about 37 C degrees.

“Ex vivo perfusion” refers to perfusion of an organ outside of the body of a human or animal that would normally include the organ.

“Perfusate” refers to a fluid used in perfusion. (Search “perfuse” on wordhippo.com. WordHippo, 2023. Web. Modified. Accessed 30 Aug. 2023.) Perfusate can also be referred to as perfusion fluid. Examples of a perfusate include fluids based on, or that include, one or more products found in blood, whole blood, blood that has been treated to remove certain blood products such as leukocytes and/or platelets, or the like. A perfusate may also include a synthetic fluid such as STEEN Solution™ or the like. Certain perfusates may be available from a donor, from a blood bank, or from a perfusate vendor.

“Revitalized Perfusate” refers to a quantity of perfusate having a state or condition that is higher or better than another quantity of perfusate used or to be used in a perfusion circuit. In certain embodiments, revitalized perfusate refers to a quantity perfusate that has undergone some form of cleaning, cleansing, purifying, or filtration process. In another embodiment, revitalized perfusate refers to a quantity perfusate that has been prepared, manufactured, or fabricated for use in perfusion but has not yet been used in a perfusion process. In another embodiment, revitalized perfusate refers to a quantity perfusate that has received an additive, a drug, and/or supplement that improves the condition of the perfusate for use in a perfusion process. In one embodiment, a revitalized perfusate is obtained by one or more components of a perfusion circuit processing the perfusate. In another embodiment, a revitalized perfusate is obtained by introducing revitalized perfusate to a perfusion circuit. In another embodiment, a revitalized perfusate is obtained by introducing revitalized perfusate to a perfusion circuit and removing a quantity of perfusate replaced by the revitalized perfusate. In one embodiment, revitalized perfusate refers to a quantity perfusate that has received a nutrient, an additive, a drug, and/or supplement that improves the condition of the perfusate for use in a perfusion process. In one embodiment, a revitalized perfusate is obtained by one or more components of a perfusion circuit processing perfusate that is already circulating in a perfusion circuit. In one embodiment, a revitalized perfusate is obtained by introducing a quantity of revitalized perfusate to a perfusion circuit. A revitalized perfusate can include a perfusate that has had one or more waste products removed. A revitalized perfusate can include a perfusate that has had one or more nutrients and/or drugs added. A revitalized perfusate can include a perfusate that has had one or more waste products removed and one or more nutrients and/or drugs added.

In certain embodiments, revitalized perfusate can include perfusate being added to a fluid circuit as well as fluids being added to the perfusate and/or fluid of the circuit due to processing that removes one or more parts of the perfusate of the circuit. For example, where a system, apparatus, or method removes an ultrafiltrate/filtrate, a revitalized, processed, and/or conditioned perfusate can include an ultrafiltrate/filtrate replacement fluid (e.g., a plasma, a serum).

“Perfusate Supply” refers to a source for a quantity of perfusate for use in perfusion.

“Extracorporeal Circuit”, “Extracorporeal Fluid Circuit”, “Extracorporeal Bypass Circuit”, or “Extracorporeal Circulation” refers to a device, apparatus, subsystem, system or the like that temporarily takes over the functions of an organ such as for example, a heart and/or lungs, during certain medical procedures. An extracorporeal circuit can involve the use of a specialized machine or system such as a perfusion system, a heart-lung machine, a cardiopulmonary bypass machine, or the like. The purpose of the extracorporeal circuit is to maintain oxygenation, circulation, and the removal of waste products from a blood or blood substitute while an organ is temporarily stopped or bypassed or included in a transplantation or experimentation process. (© ChatGPT August 3 Version, Modified, accessed chat.openai.com/chat Aug. 31, 2023). Generally, an extracorporeal circuit can include a plurality of machines, devices, systems, subsystems, apparatuses, one or more conduits for conveying fluid between members of the extracorporeal circuit, a plurality of valves, sensors, monitors, one or more controllers, reservoirs, user interfaces, and the like.

“Fluid Circuit” refers to a closed-loop and/or interconnected apparatus, device, structure, assembly and/or system of conduits including pipes or tubes, valves, pumps, and other components devices or systems that are configured, engineered, and/or designed to control the flow of fluids, such as liquids or gases, within a specific process or application. (© ChatGPT August 3 Version, Modified, accessed chat.openai.com/chat Sep. 7, 2023).

“Tubing” refers to any conduit or combination of a plurality of conduits organized, configured, designed, arranged, connected, coupled, or engineered to convey a fluid from an origin to a destination. In certain embodiments, tubing can be used in a fluid circuit.

“Pump” refers to an apparatus, instrument, structure, member, device, component, system, or assembly structured, organized, configured, designed, arranged, or engineered to convey a fluid. In certain embodiments, a pump may convey a fluid within a conduit, out of a conduit, from a storage structure, or out of a storage structure. In certain embodiments, a pump can convey a fluid within a fluid circuit. Pumps may have different names based on the type and/or configuration of the pump. Certain pumps can be more suited to conveying a gas others can be more suited to conveying a liquid. Examples of pumps include, but are not limited to, positive displacement pumps, centrifugal pumps, reciprocating pumps, diaphragm pumps, peristaltic pumps, and the like. For a medical or biological application, a peristaltic pump may be used to mitigate contamination of a fluid pumped by the pump.

“Reservoir” or “Fluid Reservoir” refers to an apparatus, instrument, structure, member, device, component, system, or assembly structured, organized, configured, designed, arranged, or engineered to store, retain, or hold a fluid. In certain embodiments, a reservoir may include a plurality of components coupled to, connected to, and/or integrated with the reservoir. In certain embodiments, a reservoir is an open container. In one embodiment, a reservoir is a closed, sealed container. In one embodiment, a reservoir includes a lid or cap that enables the reservoir to operate either open or closed and/or sealed. In certain embodiments, a reservoir can include a plurality of containers or chambers.

“Flow Diversion System” refers to any apparatus, device, system, structure, combination of these, or the like is engineered, designed, configured, and/or implemented to divert a fluid flowing in a first path to flow, at least partially a second path. A flow diversion system can include clamps, valves, levers, knobs, handles, controls, and the like, that may be manually operated, machine operated, electronically controlled actuator operated, or any combination of these. Examples of a flow diversion system include, but are not limited to, a set of clamps an operator can strategically deploy along a circuit path to divert a fluid, a set of mechanical valves, switches, or actuators positioned along a fluid path or fluid circuit, and/or a combination of these which may be activated manually by an operator and/or automatically be an electronic controller.

“Parallel diversion system” refers to a type of flow diversion system in which an apparatus, devices, system, structure, or the like is engineered, designed, configured, and/or implemented to divert a fluid flowing in a first path to flow both in the first path and in a second path such that at least a portion of the fluid flows in both the first path and the second path. In certain embodiments, a parallel diversion system is a binary parallel diversion system such that transitioning a fluid from the first path to both the first path and the second path results in approximately fifty percent of the fluid flowing in both the first path and the second path. Activating the parallel diversion system transitions fluid flow in the first path from substantially no fluid flow to a fifty percent fluid flow. In another embodiment, a parallel diversion system is a proportional diversion system such that transitioning a fluid from the first path to both the first path and the second path results in fluid flow in the second path increasing to a proportion of fluid flow that is equal to one minus a percentage of the fluid flowing in a fluid path that includes both the first path and the second path such that combining a percentage of the fluid flowing in the first path and a percentage of the fluid flowing in the second path substantially equals one hundred percent of the fluid flowing in the fluid path.

“Sequential diversion” refers to a type of flow diversion system in which an apparatus, devices, system, structure, or the like is engineered, designed, configured, and/or implemented to divert a fluid from a first path to a second path such that the fluid flow transitions from flowing along the first path to flowing along the second path.

“Sweep gas” refers to a gas mixture (often oxygen and air) used to remove waste gases such as carbon dioxide (CO2) and other waste gases from a respiratory system or within an extracorporeal circuits such as those used in perfusion systems including, but not limited to, normothermic ex-vivo perfusion system (NEVP), cardiopulmonary bypass (CPB) during cardiac surgery, and/or in extracorporeal membrane oxygenation (ECMO). (© ChatGPT August 3 Version, Modified, accessed chat.openai.com/chat Aug. 30, 2023).

“Waste Gas” refers to a gas or gas mixture that has or can have a negative influence on a thing or a system. Examples of waste gases include, but are not limited to, Carbon Dioxide (CO2), Methane (CH4), Sulfur Dioxide (SO2), Nitrogen Oxides (NOx), Volatile Organic Compounds (VOCs), and the like.

Kilodalton (kDa) refers to a unit of measurement used in biochemistry and molecular biology to express the molecular weight or mass of molecules, particularly proteins, peptides, and other large biological molecules. The Dalton (Da), also known as the unified atomic mass unit (u), is a unit of mass used to describe the mass of atoms and molecules on a molecular scale. It is defined as one twelfth the mass of an atom of carbon-12. (© ChatGPT August 3 Version, accessed chat.openai.com/chat Aug. 31, 2023).

“Cardioplegic solution” or “cardioplegia” refers to a specialized solution used during cardiac surgery to temporarily stop the heart's activity and protect the heart from damage while a surgical procedure is being performed. The cardioplegic solution can be infused into a heart's coronary arteries to induce controlled cardiac arrest, allowing a medical person to work on the heart in a bloodless and motionless state. (© ChatGPT August 3 Version, Modified, accessed chat.openai.com/chat Aug. 31, 2023).

“Metabolic waste” refers to the waste products and byproducts generated during the metabolic processes that occur within living organisms. Metabolism is the set of chemical reactions that take place within cells to maintain life and carry out various physiological functions. These metabolic processes involve the breakdown of nutrients, energy production, and the synthesis of essential molecules. Examples of metabolic waste substances include, but are not limited to, Carbon Dioxide (CO2), Creatinine, Lactic Acid, and the like.

“Controller” refers to any hardware, device, component, element, or circuit configured to manage, implement, or control the features, functions, and/or logic for a device, component, apparatus, or system, and may comprise one or more processors, onboard memory, registers, cores, programmable processors (e.g., FPGAs), programmable logic devices, complex programmable logic devices (CPLD), mixed-signal CPLDs, ASICs, micro-controllers (MCU), central processing unit (CPU), electronic circuits, or the like. A controller may execute one or more of predefined software in the form of microcode, firmware, embedded state machine code, executable code, scripts, and/or the like.

“Control System” refers to a collection of interconnected components or devices that work together to manage, regulate, or manipulate the behavior of a system or process. One purpose of a control system can be to ensure that a desired outcome or setpoint is achieved by continuously monitoring the system's performance and making necessary adjustments in real-time to maintain the desired conditions or performance criteria. Certain components of a control system may include Input: Sensors or instruments that measure and collect data or information about the current state or condition of the system. These sensors provide feedback to the control system; Controller: The central component responsible for processing the feedback information and making decisions or calculations to adjust the system's behavior. Controllers can be implemented using hardware (like microcontrollers or PLCs) or software (in the case of software-based control systems); Actuators: Devices that receive control signals from the controller and carry out physical actions or adjustments to the system. Actuators can include motors, valves, pumps, or any other mechanism that can effect change in the system; Feedback Loop: The feedback loop is part of the control system that continuously compares the actual state of the system (as measured by sensors) with the desired state or setpoint. The controller uses this feedback to determine whether adjustments are needed.

“Parameter” refers to a limit or boundary which defines the scope of a particular structure, system, assembly, setting, process, function, operation, and/or activity. (Search “parameter” on wordhippo.com. WordHippo, 2023. Web. Modified. Accessed 30 Aug. 2023.)

“Perfusion Parameter” refers to a parameter for managing, controlling, monitoring, assessing, evaluating, and/or operating a perfusion process and/or system.

“Characteristic” refers to any property, trait, quality, or attribute of an object or thing. Examples of characteristics include, but are not limited to, condition, readiness for use, error condition, performance, behavior, a data value, a measurement, a setting, a feature, a function, electrical current leakage, unreadiness for use, size, weight, composition, feature set, and the like.

“Viability” refers to the ability of an organ to perform its functions effectively and to sustain life. (© ChatGPT August 3 Version, Modified, accessed chat.openai.com/chat Sep. 7, 2023).

“Diverter” refers to a structure, device, apparatus, member, component, system, assembly, module, or subsystem that is organized, configured, designed, arranged, or engineered to divert or change a path or a direction of an object. If the object is a fluid, a diverter is a structure, device, apparatus, member, component, system, assembly, module, or subsystem that changes a direction of flow and/or a path for the fluid. A diverter can be in an active state and an inactive state and/or a neutral state. In an active state, a diverter changes a direction or path for an object such as a fluid. In an inactive state, a diverter does not change a direction or path for an object such as a fluid. In neutral state, a diverter may neither change a direction or path or not change a direction or path for an object such as a fluid.

The term “diverter” can be used with a modifier describing what part of a fluid flow is being diverted. For example, an “inlet diverter” refers to a diverter configured and/or oriented to change a path or direction of fluid flow at or near an inlet part of a fluid flow. Similarly, an “outlet diverter” refers to a diverter configured and/or oriented to change a path or direction of fluid flow at or near an outlet part of a fluid flow. In addition, the term “diverter” can be used with a modifier describing a part, a section, or a component of a fluid path that the diverter is a diverter for. For example, a “filter diverter” refers to a diverter that enables diversion of a fluid before the fluid comes to a filter.

“Supply Reservoir” refers to a reservoir that serves as a source for a quantity of a fluid.

“Bulk Perfusate Diversion System” refers to a diversion system, structure, subsystem, device, apparatus, assembly, or the like that is organized, configured, designed, arranged, or engineered to divert, exchange, and/or replace a large quantity of perfusate within a fluid circuit, where large is a quantity between about forty-five percent and about sixty percent of the perfusate volume in a perfusate circuit. In one embodiment, large can be a quantity greater than or equal to about twenty-five percent of the perfusate volume in a perfusate circuit. For example, suppose a quantity of perfusate within a fluid circuit is between about 600 cc to about just less than 1000 cc. For such an example, a large quantity of may be between about 150 cc and about 250 cc. In another example a quantity of perfusate within a fluid circuit may be between about 1500 cc. For such an example, a large quantity of is between about 375 cc.

In certain embodiments, a bulk perfusate diversion system is configured to divert, exchange, and/or replace a large quantity of perfusate within a fluid circuit with minimal interruption to a flow within a fluid circuit. In another embodiment, a bulk perfusate diversion system is configured to divert, exchange, and/or replace a large quantity of perfusate within a fluid circuit during a single cycle of a fluid pump of the fluid circuit or a relaxation or pause in function of a perfused organ, for example, a diastole of a heart in working mode.

“Bulk Removal” refers to any process that removes a quantity greater than or equal to about twenty percent of the perfusate volume in a perfusate circuit.

“Filter Diversion System” refers to any system, structure, subsystem, device, apparatus, assembly, or the like that is organized, configured, designed, arranged, or engineered to divert a fluid from a first path to a second path. In one embodiment, a filter diversion system can divert the fluid from a first filter to a second filter. A filter diversion system can be used to divert a fluid flow from the first path to the second path so that a filter on the first path can be removed and/or replaced. Those of skill in the art will appreciate that a filter diversion system can be implemented in a variety of ways and/or using a variety of components and/or instruments.

For example, in one embodiment, a filter diversion system can include a “Y” connector connected in a fluid circuit with one branch of the “Y” being an input, a second branch being an output branch conveying the fluid to a first filter, and a third branch being an output branch conveying the fluid to a second filter. The filter diversion system can include a first clamp or first valve on the second branch that is closed or clamped to stop fluid flow through the first filter and a second clamp or second valve on the third branch that is opened or released to enable the fluid to flow through the second filter. In another example, a filter diversion system can include a common housing that houses a first filter and second filter and has a common inlet port that connects to a diverter valve having a first setting and a second setting. With the diverter valve in the first setting the fluid can pass through the first filter and not the second filter and with the diverter valve in the second setting the fluid can pass through the second filter and not the first filter. Such a configuration can also be a filter diversion system in accordance with the present disclosure.

“User interface” refers to component, module, device, system, software, hardware, or apparatus that enables one or more people to provide user input, communicate, and/or interact with an electronic or computing device using mechanical, electronical, manual, audio, visual, or tactile input. In one example, a user interface may refer to one or more mechanical, electrical, or electromechanical structures that interact with, or enable, a user to provide user input, instructions, input signals, data, or data values and receive output, output data, or feedback.

“Input data” refers to data identified, used, collected, gathered, and/or generated to serve as input to another component, circuit, driver, device, manager, control circuit, storage media, storage device, or controller. The input data can be in analog or digital format and can represent a data signal, a control signal, and/or one or more data values.

“Control signal” refers to an electrical signal (wired or wireless) designed, engineered, and/or provided to control, manage, direct, instruct, or monitor another component, device, circuit, apparatus, system, and/or assembly.

“Code” or “Executable Code” refers to a set of instructions configured for reading and executing by a processor of a computing device. The code may exist in machine-readable and/or human readable formats. Examples of code include binary code, machine code, scripts, compiled code, virtual machine code, and the like.

“Volatile memory media” or “memory” refers to any hardware, device, component, element, or circuit configured to maintain an alterable physical characteristic used to represent a binary value of zero or one for which the alterable physical characteristic reverts to a default state that no longer represents the binary value when a primary power source is removed or unless a primary power source is used to refresh the represented binary value. Examples of volatile memory media include but are not limited to dynamic random-access memory (DRAM), static random-access memory (SRAM), double data rate random-access memory (DDR RAM) or other random-access solid-state memory. While the volatile memory media is referred to herein as memory media, in various embodiments, the volatile memory media may more generally be referred to as volatile memory. In certain embodiments, data stored in volatile memory media is addressable at a byte level which means that the data in the volatile memory media is organized into bytes (8 bits) of data that each have a unique address, such as a logical address.

“Mode” or “Operation mode” refers to a state of operation for a circuit, sub-circuit, circuitry, electronic component, hardware, software, firmware, module, logic, device, button, lever, control loop, or apparatus. When a mode is activated the circuit, sub-circuit, circuitry, electronic component, hardware, software, firmware, module, logic, device, control loop, or apparatus may perform a set of functions that are different or use different parameters from when the mode is not activated. Alternatively, or in addition, one operation mode may be controlled and/or managed by a user (referred to herein as a manual operation mode), may be partially controlled and/or managed by a user (referred to herein as a semi-automated operation mode), or may be completely controlled and/or managed by logic, executable code, a system, subsystem, or apparatus within out any input or control by a user (referred to herein as an automated operation mode).

In certain embodiments, a mode may be represented by one or more states in a state machine. Often “mode” is used with a modifier describing and differentiating one mode or operating state from another, for example an “operating mode” or “operation mode” relates to a mode of operation, a “calibration mode” relates to a mode of calibrating, a “distance mode” relates to distance operations, an “orientation mode” relates to navigational operations, and an “angle mode” relates to angles.

“User input” refers to any signal, action, or other indication from a user that provides direction, instruction(s), and/or information a user wants to provide to a device, apparatus, member, component, system, assembly, module, subsystem, circuit. In certain embodiments, user input can include input data provided by a user or operator. In certain embodiments, a user may provide user input using an input device such as a touchscreen, a mouse, a switch, a lever or the like. A variety of signals, indicators, indications, gestures, movements, touches, keystrokes, or the like can serve as user input.

“Storage device” or “Storage” refers to any hardware, system, sub-system, circuit, component, module, non-volatile memory media, hard disk drive, storage array, device, or apparatus configured, programmed, designed, or engineered to store data for a period of time and retain the data in the storage device while the storage device is not using power from a power supply. Examples of storage devices include, but are not limited to, a hard disk drive, FLASH memory, MRAM memory, a Solid-State storage device, Just a Bunch Of Disks (JBOD), Just a Bunch Of Flash (JBOF), an external hard disk, an internal hard disk, and the like.

“Closed loop” refers to any system that is controlled, managed, adjusted, and/or configured based on a feedback loop or control loop that provides a value, setting, threshold, and/or input that is provided into the same system.

“Control Loop” refers to a closed-loop process, method, or system that continuously monitors and adjusts a process to maintain a desired setpoint or target. Control loops can regulate and optimize processes, ensuring the processes operate within specified parameters and deliver consistent and reliable results. A control loop often includes the following components:

Process: The process is the system or operation that needs to be controlled or regulated. This could be a manufacturing process, a heating or cooling system, a chemical reaction, a biological process, a physiological process, or any other system with variable inputs, outputs, and/or parameters.

Setpoint: The setpoint is the desired or target value that the process should achieve or maintain. The setpoint represents the ideal operating condition for the process.

Sensor (or Measuring Device): The sensor is a device that measures the current state, condition, or output of the process or one or more components and/or stages of a process. The sensor provides feedback for an actual process variable (PV) and sends this information to a controller.

Controller: The controller can be a device and/or software of a computing device that receives input from the sensor and compares the input to the setpoint. Based on this comparison, the controller calculates the necessary control action to bring the process variable back to the setpoint.

Actuator: The actuator is a device, component, or mechanism that receives signals from the controller and physically adjusts the process or components or other aspects of a process to achieve the desired setpoint. The adjusted aspect could be a valve position, flow rate, flow pressure, motor revolutions per minute, motor on or off state, gate or port state (open or closed), proportional pinch valve position, heater/cooler increasing or decreasing heat/cold output, mass flow control (e.g., sweep gas flowrate) or any other device that can change a parameter of the process.

Feedback Loop: The feedback loop is the continuous flow of information and control signals between the sensor, controller, and actuator. The feedback loop allows the controller to make real-time adjustments to keep the process variable close to or at the setpoint.

A control loop can include one or more of setpoints, sensors, controllers, actuators, and/or feedback loops.

The basic operation of a control loop involves the controller comparing the actual process variable (PV) with the setpoint (SP) and generating a control signal that instructs the actuator to make adjustments. The process variable can be continuously measured and controlled to minimize deviation from the setpoint, ensuring that the process operates efficiently and within desired limits. (© ChatGPT August 3 Version, Modified, accessed chat.openai.com/chat Sep. 7, 2023).

“Protocol” refers to a set of instructions, settings, parameters, preconditions, tools, devices components, and the like for performing a specific method or process. A protocol can have a variety or forms and/or formats and can be communicated using a variety of means, devices, and/or methods. For example, a protocol can be defined by a set of data, a set of parameters, a list of components, a list of conditions, a set of thresholds, a set of text, a series or sequence of steps and/or instructions, or any combination of these.

As used herein, “Attribute” refers to any property, trait, element, characteristic, aspect, quality, data value, setting, or feature of an object or thing.

“Threshold” refers to a level, point, or value above which a condition is true or will take place and below which the condition is not true or will not take place, or vice versa. (Search “threshold” on Merriam-Webster.com. Merriam-Webster, 2019. Web. 14 Nov. 2019. Modified.)

“Set” refers to a collection of objects. A set can have zero or more objects in the collection. Generally, a set includes one or more objects in the collection.

“Perfusion Protocol” refers to a protocol that can be used to setup, prime, initiate, perform, and/or complete a perfusion process or procedure. In one embodiment, a perfusion protocol may outline standardized, predetermined, or accepted steps and parameters or initial settings for conducting a perfusion procedure. A perfusion protocol might include details such as: a) Equipment setup and calibration, b) Patient preparation and monitoring, c) Anticoagulation procedures to prevent blood clotting, d) flow rates and pressures for a perfusion circuit, e) Oxygenation and temperature control, f) Monitoring and recording vital signs and blood parameters, g) Troubleshooting guidelines for any issues that may arise during the procedure, and the like. (© ChatGPT August 3 Version, Modified, accessed chat.openai.com/chat Sep. 8, 2023). In certain embodiments, a perfusion protocol can include one or more perfusion modes. Examples of perfusion modes include but are not limited to. “Partial Working Mode Perfusion”, “Left Atrial Perfusion”, “Langendorff perfusion”, “Beating Heart, Resting Mode”, “Working Mode Perfusion”, and the like.

“Langendorff perfusion” or “Beating Heart, Resting Mode” refers to a perfusion procedure, process, method, or mode for an ex vivo heart organ. The procedure involves perfusing a donor heart using a perfusion circuit to pump perfusate in a retrograde manner into the ligated aorta and antegrade through the coronary arteries of the heart to nourish the donor heart and remove waste. The perfusate circulates through the coronary arteries and back into the right atrium of the donor heart, then into the right ventricle, returning thru cannula and tubing to the perfusion reservoir via the pulmonary artery, and eventually back into the aorta and coronary arteries after having been reoxygenated. The perfusion procedure is named for Otto Langendorff who developed the procedure.

“Working Mode Perfusion” refers to a perfusion procedure, process, method, or mode for an ex vivo heart organ. The procedure involves perfusing a donor heart using a perfusion circuit such that the donor heart pumps a perfusate supplied to the left atrium into the left ventricle and then into the aorta and into coronary arteries. From the aorta, the perfusate passes through one or more compliance and/or resistance components designed to simulate the compliance and resistance the ex vivo heart would experience in the body of a recipient. The perfusate exits the compliance and/or resistance components into a perfusion reservoir. The perfusate also circulates through the coronary arteries and back into the right ventricle of the donor heart, where it joins a perfusate supplied to the right atrium which is pumped by the heart into the right ventricle which pumps perfusate into the pulmonary artery. From the pulmonary artery, the perfusate passes through one or more compliance and/or resistance components designed to simulate the pulmonary compliance and pulmonary vascular resistance the ex vivo heart would experience in the body of a recipient, returning into the perfusion reservoir, and eventually back into the left and right atria to repeat the perfusion circuit after having been reoxygenated. The Working Mode Perfusion procedure is intended to simulate operation of the ex vivo heart in a recipient.

“Partial Working Mode Perfusion” or “Left Atrial Perfusion” refers to a perfusion procedure, process, method, or mode for an ex vivo heart organ. The procedure involves perfusing a donor heart using a perfusion circuit such that the donor heart pumps a perfusate supplied to the left atrium into the left ventricle and then into the aorta and into coronary arteries. From the aorta, the perfusate passes through one or more compliance and/or resistance components designed to simulate the compliance and resistance the ex vivo heart would experience in the body of a recipient. The perfusate exits the compliance and/or resistance components into a perfusion reservoir. The perfusate also circulates through the coronary arteries and back into the right ventricle of the donor heart, then through the right atrium, the right ventricle, and the pulmonary artery into the perfusion reservoir, and eventually back into the left atrium to repeat the perfusion circuit after having been reoxygenated. The partial working mode perfusion procedure is intended to simulate operation of the left side of the ex vivo heart.

“Filtrate Replacement Fluid” (FRF) or “Ultrafiltrate Replacement Fluid” (UFRF) refers to any fluid used in a perfusion procedure, perfusion circuit, and/or perfusion process. Typically, a FRF is supplied into a perfusion circuit in relation to an amount of filtrate and/or ultrafiltrate removed from the perfusion circuit. In certain embodiments, FRF is infused into the perfusion circuit at substantially the same rate as filtrate and/or ultrafiltrate is removed from the perfusion circuit. In another embodiment, FRF is infused into the perfusion circuit at a greater rate than filtrate and/or ultrafiltrate is removed from the perfusion circuit. In another embodiment, FRF is infused into the perfusion circuit at a lesser rate than filtrate and/or ultrafiltrate is removed from the perfusion circuit. FRF can include a variety of materials and can be a mixture and/or a composition. Examples of FRF include, but are not limited to, a blood plasma, natural donor blood, blood products that have been processed to remove certain blood products such as leukocytes and/or platelets, blood substitutes, synthetic perfusates, and the like.

“Perfusate Filtration System” refers to any system that filters perfusate. A perfusate filtration system can be integrated with and in line with a fluid circuit or a perfusate filtration system can be separate and independent of a fluid circuit.

“Interrupt” or “interrupting” refers to any stoppage, break, break in continuity, or delay, in a process, flow, sequence, period of time, or the like. In certain embodiments, “Interrupt” or “interrupting” also refers to any stoppage, break, break in continuity, or delay, in a process, flow, sequence, flow, period of time, or the like that negatively impacts the interrupted process, flow, sequence, period of time. Thus, in certain embodiments, a time delay and/or break in flow for a fluid can exist and/or can be greater than zero and not be “interrupting” so long as the impact does not negatively affect the interrupted process, flow, sequence, period of time.

“Perfusate Hemofiltration System” refers to any system that performs hemofiltration on perfusate. A perfusate hemofiltration system can be integrated with and/or in line with a fluid circuit or a perfusate hemofiltration system can be separate and independent of a fluid circuit. One example of a perfusate hemofiltration system is Prismaflex HF1000 available from Baxter, Inc. of Opelika Alabama.

“Perfusate Supply Exchange System” refers to any system that exchanges a quantity of between about forty-five percent and about sixty percent of a perfusate in a perfusion circuit with another quantity of between about forty-five percent and about sixty percent of a replacement perfusate or another replacement fluid for the perfusion circuit. In certain embodiments, a perfusate supply exchange system can include any system that exchanges a quantity of between about ten percent of a perfusate in a perfusion circuit and about thirty percent of a perfusate in a perfusion circuit with an approximately equal amount of perfusate in the perfusion circuit. In certain embodiments, a perfusate supply exchange system can include any system that exchanges a quantity of at least twenty percent of a perfusate in a perfusion circuit with an approximately equal amount of perfusate in the perfusion circuit. A perfusate supply exchange system can be integrated with and/or in line with a fluid circuit or a perfusate supply exchange system can be separate and independent of a fluid circuit. One example of a perfusate supply exchange system is dual chamber/bladder disclosed herein.

“Continuously Refreshed Perfusate” refers to a quantity of perfusate that is refreshed from a suboptimal state to a more optimal state without interrupting, disrupting, or stopping fluid flow within a perfusion circuit. As used herein, continuous refers to a process with no break or interruption, as well as a process with a nominal break or interruption, as well as a process with a break or interruption that is small or short enough that one or more perfused organ experiences nominal or no adverse effects from the break or interruption. Those of skill in the art will appreciate that the perfusate can be refreshed using a variety of methods, processes, techniques, devices, structures, systems, apparatuses, and the like. For example, the perfusate can be refreshed by way of one or more inline filters, a hemofiltration process (conducting using mechanical devices and/or living organs), a bulk perfusate exchange process, a constant perfusate replacement process, a dialysis process, a blood gas exchange process, a pH adjustment process, a temperature adjustment process, an oncotic pressure adjustment process, an addition of one or more nutrients, an addition of one or more additives, an addition of one or more supplements, an addition of one or more drugs, or the like.

“Measured Parameter” refers to any parameter that can be measured for a particular device, apparatus, process, method, circuit, or the like. In the context of a perfusion circuit, a measured parameter can include any perfusion parameter that can be measured. Examples of measured parameters in a perfusion circuit, can include, a flow rate, a fluid pressure, a temperature, a weight, an Oxygen saturation (SO2) level, an oxygen (CaO2) content level, Oxygen utilization, Oxygen extraction, vascular resistance, aortic insufficiency level, ventricular P-V loop characteristics, glucose level, lactate level, a pH level, a hematocrit level, a carbon dioxide (pCO2) partial pressure level, a carbon dioxide content (% CO2), electrocardiogram (EKG) reading, beat rate of heart, a partial pressure of Oxygen (pO2), a motor speed, filtrate removal rate, gas flowrate, and the like.

“Port” refers to an opening configured, engineered, and/or designed for passage of a fluid. Often “port” is used with a modifier describing and differentiating a direction of flow of a fluid through the port. For example, an “inlet port” refers to a port configured and/or oriented to allow a fluid to pass through the port and into a container or other vessel. An “outlet port” refers to a port configured and/or oriented to allow a fluid to pass through the port and out of a container or other vessel. Similarly, “port” can be used with a modifier that identifies the container or vessel to which the port enables fluid communication of the fluid. For example, a “reservoir inlet port” refers to a port that enables a fluid to pass into a reservoir. Similarly, a “reservoir outlet port” refers to a port that enables a fluid to pass out of a reservoir.

“Cap” refers to any structure, system, subsystem, device, apparatus, assembly, or the like that is organized, configured, designed, arranged, or engineered to serve as a closure for a container. In one embodiment, a cap is a specific form of lid that is designed to cover and secure the opening of a container. Caps can be used to seal containers such as bottles, jars, reservoirs, housings, and tubes, and caps can provide various functions such as sealing, preventing spills, preserving the contents, and/or protecting against contamination. Caps can be different forms, including screw caps, snap-on caps, press-on caps, and twist-off caps, depending on the design of the container and the specific requirements of the closure. (© ChatGPT August 3 Version, Modified, accessed chat.openai.com/chat Sep. 8, 2023).

“Filter Media” refers to any material or substance used in a filtration system to separate particles or impurities from a fluid (liquid or gas). Filter media can be composed of various materials and come in different forms to suit specific filtration applications. The choice of filter media depends on factors such as the type and size of particles to be removed, the properties of the fluid being filtered, and the efficiency and durability required for the filtration process.

Common types of filter media include Mechanical Filter Media: These are physical barriers that capture particles based on size. Examples include mesh screens, filter paper, and fabric materials like cotton or polyester. Mechanical filter media function by physically trapping particles larger than the pore size of the material; Activated Carbon: Activated carbon is a highly porous material with a large surface area that can adsorb and remove impurities, such as organic compounds and odors, from liquids and gases; Ceramic Filter Media: Ceramic materials, like ceramic foam or ceramic membranes, are used for filtering solids from liquids and gases. They are often used in water purification processes; Sand and Gravel: In applications like water treatment and pool filtration, sand and gravel are commonly used as filter media to remove particles and impurities from water; Diatomaceous Earth (DE): DE is a natural, finely powdered material that is used as a filter aid in pool filters and certain industrial filtration processes to remove fine particles; Fibrous Filter Media: Fibrous materials, such as fiberglass, cellulose, or synthetic fibers, are used in air filtration and HVAC systems to capture airborne particles, including dust and allergens; Membrane Filter Media: Membranes made of materials like polymeric films or ceramic are used to achieve precise filtration by blocking particles based on size. They can be common in applications like laboratory filtration and pharmaceutical processes; Pleated Filter Media: Pleated filter materials provide a larger filtration surface area in a compact space, improving filtration efficiency and extending the lifespan of filters. They are used in various filtration systems. (© ChatGPT August 3 Version, Modified, accessed chat.openai.com/chat Sep. 8, 2023).

Currently, organs procured for transplantation should be implanted within six hours. In the case of a heart transplant, if hearts are stored longer than about six hours, subsequent function is compromised resulting in increasing post-transplant morbidity and mortality.

Organ transplantation is often urgent and limited by time, distance, and recipient matching. These limitations exist regardless of the method of organ preservation used today (cold storage, cold perfusion, warm perfusion). These limitations can negatively impact the availability of donor hearts, for example. Advantageously, the present disclosure extends the ex-vivo preservation period for organs to 24 hours or more. Consequently, transplantation procedures can be seen as more elective have few if any time and distance limitations. In addition, during prolonged ex-vivo preservation, tissue matching can be optimized and organs can be treated and organ functional assessment can be made resulting in expanded use of donor organs.

The present disclosure discloses apparatuses, systems, and method for perfusion that extends the viability of an ex vivo perfused organ up to a number of days, rather than a few hours. The present disclosure discloses apparatuses, systems, and method for perfusion includes automation of one or more steps or stages and/or control loops of a perfusion process such that less burden is placed on an operator. Alternatively, or in addition, a single operator can manage a plurality of perfusion systems using the embodiments of the present disclosure. The present disclosure discloses apparatuses, systems, and method for perfusion that enable certain control loops to be managed manually while others are managed automatically. In this manner, an operator has complete flexibility as to how much automation to include in a perfusion process for an organ. The present disclosure discloses apparatuses, systems, and method for perfusion that can respond faster than an operator to changing perfusion parameters and/or conditions to make adjustments that will enable extended, long-term viability of the perfused organ. The present disclosure discloses apparatuses, systems, and method for perfusion that provides conditioned perfusate to a perfusion circuit of a perfusion process without any delay, interruption, or stoppage that negatively affects perfusion of the organ.

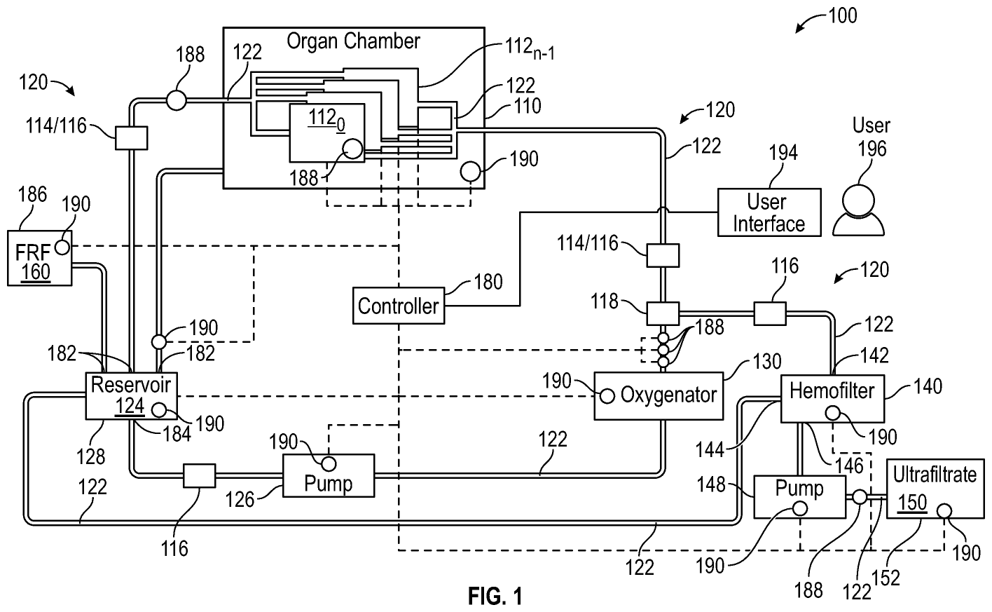

FIG. 1 is a block diagram depicting an exemplary system 100 for perfusing at least one organ, according to one embodiment. The system 100 may be used to maintain at least one organ ex vivo for any of a wide variety of clinical and/or medical research purposes. In one embodiment, the system 100 provides ex vivo perfusion. In particular, the system 100 can provide Normothermic Ex Vivo Perfusion (NEVP) or Normothermic Perfusion for one or more organs.

The system 100 can include an organ chamber 110, a fluid circuit 120, and a controller 180. The organ chamber 110 houses at least one organ 112 that is receiving Normothermic Perfusion (NEVP). A variety of different types or configurations of organ chambers 110 can be used with the system 100 depending on the number of organs receiving NEVP and the type of organs receiving NEVP. In certain embodiments, the organ chamber 110 encloses the at least one organ in a controlled environment that is protected from external contamination, harm, or influence. The controlled environment of the organ chamber 110 can also help maintain a desired humility, gas composition, and temperature within the organ chamber 110 for the benefit of the at least one organ 112.

In certain embodiments, the organ chamber 110 is made from clear plastic or glass and may include a base and a dome shaped over with access ports for one or more tubes that connect to the one or more organs and couple to the fluid circuit 120. Those of skill in the art will appreciate that a variety of different organ chambers 110 can be used with the system 100 including reusable organ chambers 110 and disposable organ chambers 110.

In the illustrated embodiment, the organ chamber 110 illustrates a plurality of organs 112 (organ 112₀-organ 112n−1). Those of skill in the art will appreciate that the organ chamber 110 can include one organ 112 or a plurality of organs 112 each connected to either the same fluid circuit 120 or each connected to a separate fluid circuit 120. In one example, the organ chamber 110 may include a lung and a heart organ from a common donor and connected to the same fluid circuit 120.

The fluid circuit 120 can include tubing 122 that carries a perfusate 124, one or more pumps 126, a reservoir 128, an oxygenator 130, a hemofilter 140, and a filtrate replacement fluid 160.

The tubing 122 serves to couple, connect, and/or interconnect components of the fluid circuit 120 such that a perfusate 124 and/or filtrate replacement fluid 160 can flow through the fluid circuit 120. In one embodiment, the tubing 122 is a biocompatible, flexible, tubing configured to use with medical fluids such as perfusate 124 and/or filtrate replacement fluid 160. In certain parts of fluid circuit 120, the tubing 122 can be a single tube while in other parts of the fluid circuit 120 the tubing 122 can include a plurality of tubes. The tubing 122 can have any diameter needed for suitable flow of perfusate 124 and/or filtrate replacement fluid 160 through the fluid circuit 120. In certain embodiments, the tubing 122 can be translucent such that an operator can see when the tubing 122 includes a fluid or when fluid filled tubing 122 includes an air emboli. As used herein, fluid refers to the perfusate 124, the filtrate replacement fluid 160, any gases passed into or expelled from the fluid circuit 120, and the like.

The tubing 122 couples to and/or can be coupled to one or more organs 112 in the organ chamber 110. In one embodiment, the tubing 122 carries fluid such as perfusate 124 to the one or more organs 112. In one embodiment, the tubing 122 carries fluid such as perfusate 124 away from the one or more organs 112. In one embodiment, the tubing 122 carries fluid such as perfusate 124 to and from the one or more organs 112. In addition to use of tubing 122 in the fluid circuit 120, the same or similar tubing 122 can be used for connecting to other components that connect to the fluid circuit 120 (e.g., the filtrate replacement fluid supply 186 or a drain tube from the organ chamber 110. One example of tubing 122 suitable for use with the system 100 is ¼ inch I. D. tubing (from Saint-Gobain, of Malvern PA).

In one embodiment, the perfusate 124 is a blood derived perfusate. The blood used as the source for the perfusate 124 can be an animal or a human. In one embodiment, the blood used as a source of perfusate 124 is from the donor of an organ 112 being perfused. In one embodiment, the perfusate 124 is a platelet and/or leukocyte reduced blood from a donor of the organ with a hemoglobin concentration of greater than about eight g/dL. After removal of platelets and/or leukocytes, electrolytes and/or metabolic abnormalities may be corrected to be within normal physiological ranges.

The pump 126 drives perfusate 124 through the fluid circuit 120. The pump 126 is coupled to the fluid circuit 120. A variety of different pumps 126 can be used with the system 100. In one embodiment, a peristaltic roller pump is used. Such a pump provides effective pumping action while mitigating damage to oxygen carriers (e.g., red blood cells) and/or nutrient carriers of the perfusate 124.

The type of pump 126 can vary depending on the number and/or type of organ 112 perfused. In one embodiment, the pump 126 is a peristaltic pump having an inlet connected to the fluid circuit 120 and an outlet connected to the fluid circuit 120. The peristaltic pump can be a one-way flow pump that moves perfusate 124 from the inlet and drives the perfusate 124 to and out of the outlet. The peristaltic pump may include shoes or rollers that move and compress tubing 122 at one or more points and drive the fluid forward. One example of a peristaltic pump suitable for use with the illustrated embodiment is the MFlow™ pump available from Daris, LLC, of Michigan USA. In certain embodiments, a peristaltic pump may be preferred as it can simulate the wave like contractions and relaxations of a muscle such as a heart (e.g., pulsatile flow and pressure characteristics of the native blood flow experienced by the organ.). Thus, a peristaltic pump may be suitable for use when perfusing a heart organ 112 or another organ 112 that responds well to perfusate 124 driven by a peristaltic pump.

The fluid circuit 120 can also include a plurality of valves 114, clamps 116, “Y” connectors 118, terminators, couplers (not shown), and the like.

The reservoir 128 retains and holds perfusate 124 for use in the fluid circuit 120. The reservoir 128 supplies the perfusate 124 to the tubing 122 for use in the fluid circuit 120. In one embodiment, the reservoir 128 can have a plurality of inlet ports 182 that can connect to the fluid circuit 120 and one or more outlet ports 184 that can connect to the fluid circuit 120. In certain embodiments, one or more of the inlet ports 182 may connect to a filtrate replacement fluid supply 186. The reservoir 128 is sized to hold a sufficient quantity for the fluid circuit 120. For example, the reservoir 128 may hold up to about 1000 mL. Of course, a reservoir 128 of any size can be used and the size of the reservoir 128 may be based on size, number, and type of organs 112 connected to the fluid circuit 120.

In one embodiment, the reservoir 128 is a rigid container made of biocompatible materials such as plastic. Alternatively, or in addition, the reservoir 128 can be a container having flexible walls that enclose a quantity of perfusate 124.

In certain embodiments, the reservoir 128 can also filter perfusate 124 in the fluid circuit 120. Alternatively, or in addition, the reservoir 128 can be a replaceable reservoir. “Replaceable Reservoir” refers to any reservoir, tank, or fluid holding structure configured, designed, and/or engineered to be replaced within a fluid circuit. A “replaceable reservoir” also refers to any reservoir, tank, or fluid holding structure configured, designed, and/or engineered to enable replacement of a quantity of fluid supplied by the replaceable reservoir. In one embodiment, a replaceable reservoir is disposable. In one embodiment, a replaceable reservoir is reusable. In one embodiment, a replaceable reservoir includes a set of chambers, for example a pair of chambers and one chamber (or the fluid of one chamber) can be replaced while another chamber is in use. In one embodiment, a replaceable reservoir includes a set of cartridges, for example a pair of cartridges and one cartridge can be replaced while another cartridge is in use.

Embodiments that use a replaceable reservoir can be referred to as a bulk perfusate diversion system that enables replacement and/or exchange of a large quantity of perfusate 124. In such an embodiment, the reservoir 128 can be referred to as a replaceable reservoir because such a large quantity of perfusate 124 is replaced or exchanged using the replaceable reservoir. In one embodiment, a whole reservoir 128 of a replaceable reservoir may be replaced with another reservoir. In another embodiment, a whole quantity of perfusate 124 can be replaced with a second quantity of perfusate 124.

Advantageously, in certain embodiments, a bulk perfusate diversion system and/or reservoir 128 (e.g., replaceable reservoir) are configured to replace perfusate 124 in a fluid circuit 120 without interrupting perfusion of the organ 112. In certain embodiments, “without interrupting perfusion of the organ 112” means no interruption, delay, or break in the timing, flow, and/or operation of a perfusion process, method, apparatus, system, and/or protocol in relation to the organ 112. In other embodiments, “without interrupting perfusion of the organ 112” means one or more interruptions, delays, or breaks in the timing, flow, and/or operation of a perfusion process, method, apparatus, system, and/or protocol in relation to the organ 112, but the one or more interruptions, delays, or breaks in the timing, flow, and/or operation are so short and/or small that the one or more interruptions, delays, or breaks in the timing, flow, and/or operation have substantially no negative effects on the organ 112. In other embodiments, “without interrupting perfusion of the organ 112” means one or more interruptions, delays, or breaks in the timing, flow, and/or operation of a perfusion process, method, apparatus, system, and/or protocol in relation to the organ 112 that are timed and/or short enough to fit within natural interruptions, delays, or breaks a particular perfusion mode and/or perfusion protocol.

In still another embodiment, “without interrupting perfusion of the organ 112” includes that one or more interruptions, delays, or breaks in the timing, flow, and/or operation of a perfusion process, method, apparatus, system, and/or protocol for replacement of the perfusate 124 are timed or arranged to coincide with natural breaks or interruptions or delays in a flow of perfusate 124 during perfusion. For example, interruptions, delays, or breaks in the timing, flow, and/or operation may be arranged to occur during a regular relaxation cycle for a peristaltic process, such as a relaxation cycle for a pump (e.g., pump 126 and/or a pulsatile pump) or a muscle such as a heart. By leveraging natural rest or relaxation phases of a perfusion process, a bulk perfusate diversion system and/or replaceable reservoir can replace perfusate 124 supplied by a reservoir 128 “without interrupting perfusion of the organ 112”.

In certain embodiments, the system 100 includes a replaceable reservoir 128 configured to supply perfusate 124 and replace perfusate 124 in the fluid circuit 120 during continuous perfusion of the organ 112. “Continuous Perfusion” refers to a type of organ perfusion in which the perfusion process, method, apparatus, system, and/or protocol operates without interruption, stoppage, or break. “Continuous Perfusion” can also refer to a perfusion process, method, apparatus, system, and/or protocol that includes an interruption, stoppage, or break, but the interruption, stoppage, or break is so small or so short that it has substantially no or little impact on the viability of a perfused organ. Alternatively, or in addition, “Continuous Perfusion” can also refer to a perfusion process, method, apparatus, system, and/or protocol that includes an interruption, stoppage, or break, but the interruption, stoppage, or break designed to overlap with a natural break or relaxation phase of an existing perfusion process, method, apparatus, system, and/or protocol. For example, suppose the system 100 is used to perfuse a heart and the pump 126 is configured to simulate the natural rhythms of contraction and relaxation of the perfused heart. In such a perfusion system of a heart organ, a replaceable reservoir 128 may replace a supply of perfusate 124 in the fluid circuit 120 during one or more relaxation cycles of the pump 126 and/or during a relaxation phase or pause or natural break for the perfused organ (e.g., during diastole of a heart organ) and in this manner replace a supply of perfusate 124 during continuous perfusion of the heart.

Advantageously, in certain embodiments, the replaceable reservoir 128 configured to supply of clean perfusate 124 that replaces perfusate 124 presently in the fluid circuit 120. “Clean Perfusate” refers to a quantity of perfusate that has an improved condition for use in perfusion relative to another quantity of perfusate. When clean perfusate 124 is supplied by a replaceable reservoir 128, the perfusate 124 in the fluid circuit 120 is original or nonclean perfusate 124 and the perfusate 124 provided by the replaceable reservoir 128 is the clean perfusate. Those of skill in the art will appreciate that “clean perfusate” can mean different things depending on embodiment implemented using the present disclosure and include under the claims of this present disclosure.

In certain embodiments, clean perfusate refers to a quantity perfusate that has undergone some form of cleaning, cleansing, processing, purifying, or filtration process. In another embodiment, clean perfusate refers to a quantity perfusate that has been prepared, manufactured, or fabricated for use in perfusion but has not yet been used in a perfusion process. In other words, the clean perfusate is new perfusate. In another embodiment, clean perfusate refers to a quantity perfusate that has received a nutrient, an additive, and/or supplement that improves the condition of the perfusate for use in a perfusion process. In one embodiment, a clean perfusate can be obtained by one or more components of a perfusion circuit (e.g., fluid circuit 120) processing perfusate that is already circulating in a perfusion circuit. In one embodiment, a clean perfusate is obtained by introducing a quantity of clean perfusate to a perfusion circuit. A clean perfusate can include a perfusate that has had one or more waste products removed. A clean perfusate can include a perfusate that has had one or more nutrients added. A clean perfusate can include a perfusate that has had one or more waste products removed and one or more nutrients added.

The reservoir 128 can also provide an access point for adding drugs and/or nutrients to the perfusate 124. The reservoir 128 can also be used to sample the perfusate 124 and determine its composition of oxygen carriers, nutrient carriers, waste, plasma, electrolytes and/or the like.

The oxygenator 130 is coupled to the tubing 122 of the fluid circuit 120 by an inlet port 132 and an outlet port 134. The oxygenator 130 exchanges oxygen gas with waste gas in the perfusate. Of course, the oxygenator 130 can introduce other gases as needed into the perfusate 124 and/or remove other gases from the perfusate 124, as needed. One example of an oxygenator 130 suitable for use with the system 100 is the FX05 Baby Capiox Oxygenator (from Terumo CVS, Ann Arbor, MI).

In one embodiment, the oxygenator 130 can include a heat exchanger that can be used to transfer heat into or out of the perfusate 124 to put the temperature of the perfusate 124 within a normothermic range for perfusion. The heating and/or cooling of the heat exchanger may be implemented using a heater/cooler device. One example of a heater/cooler suitable for use with the system 100 is available from Cincinnati Sub Zero of Cincinnati, OH.

The hemofilter 140 performs hemofiltration on the perfusate 124. The hemofilter 140 couples to the tubing 122 and removes ultrafiltrate that includes metabolic waste from the perfusate 124. In the illustrated embodiment, the hemofilter 140 includes an inlet port 142 that connects to the fluid circuit 120 to provide perfusate 124 to the hemofilter 140. The hemofilter 140 also includes an outlet port 144 that connects to the fluid circuit 120 to provide hemofiltered perfusate 124 to the fluid circuit 120.

In the illustrated embodiment, the hemofilter 140 may include a waste port 146. The waste port 146 enables coupling of the hemofilter 140 to an ultrafiltrate pump 148. The ultrafiltrate pump 148 pumps ultrafiltrate 150 from the waste port 146 to a ultrafiltrate collector 152 (e.g., waste reservoir).

In one embodiment, the hemofilter 140 is a convection filter. In one embodiment, that includes the hemofilter 140, perfusate 124 flows through the center of an array of hollow fibers which have pore sizes to allow molecules of less than or equal to a molecular weight of about 22 kDa to pass through as ultrafiltrate 150 (aka filtrate) due to a pressure differential across the membrane. In another embodiment, the hemofilter 140 is configured to filter out allow molecules of less than or equal to a molecular weight of about 5 kDa. In another embodiment, the hemofilter 140 is configured to filter out allow molecules of less than or equal to a molecular weight of about 66 kDa. In another embodiment, the hemofilter 140 is configured to filter out allow molecules of less than or equal to a molecular weight of about 100 kDa. The hemofilter 140 filters very small molecules out of the perfusate 124. One example of a hemofilter 140 suitable for use with the system 100 is the Prismaflex HF1000 available from Baxter International Inc. of Deerfield, IL.

In one embodiment, the hemofilter 140 may include an ion selective permeable membrane(s) configured to allow equilibration of ions across the membrane using ionic pressures. By modulating the ionic pressure on one side of the membrane relative to the perfusate 124 can cause the filtration of the ultrafiltrate 150.

In one embodiment, the ultrafiltrate 150 passes readily through the hemofilter 140. Accordingly, the system 100 may control the rate of withdrawal of ultrafiltrate 150 by using a roller pump 148 as shown. In this manner, the system 100 avoids filtering out too much ultrafiltrate 150 too quickly. The pump 148 is in contact only with the ultrafiltrate 150 or “waste” which has no formed elements of blood (no red blood cells). The ultrafiltrate 150 is collected in the ultrafiltrate collector 152 (aka a waste reservoir). The ultrafiltrate collector 152 can be connected to weight sensors to enable monitoring of the amount of ultrafiltrate 150 collected.

Of course, the rate of removal of ultrafiltrate 150 can vary. However, in one embodiment, the filtration rate can be about a few mL/hour. Accordingly, the weight sensor on the ultrafiltrate collector 152 can be sensitive enough to determine both the volume and rate of ultrafiltrate 150 withdrawal.

The filtrate replacement fluid 160 is a fluid prepared as a replacement for ultrafiltrate 150 removed by the hemofilter 140. In the illustrated embodiment, the filtrate replacement fluid 160 is coupled to the fluid circuit 120 at the reservoir 128. In one embodiment, the filtrate replacement fluid 160 may flow into the reservoir 128 by way of gravity. Alternatively, or in addition, a pump (not shown) can supply filtrate replacement fluid 160 to the fluid circuit 120. Those of skill in the art will appreciate that filtrate replacement fluid 160 can be provided to the fluid circuit 120 at a variety of points in the fluid circuit 120. For example, the filtrate replacement fluid 160 can be supplied from the filtrate replacement fluid supply 186 into the reservoir 128, at a valve or other access point along the fluid circuit 120, within the oxygenator 130, at or within the hemofilter 140, or the like. In one embodiment, the filtrate replacement fluid 160 is a blood-based serum which does not have any formed elements (blood cells).

The controller 180 is coupled to the fluid circuit 120. The controller 180 manages a plurality of perfusion parameters of the fluid circuit 120 to perfuse one or more organs 112 in the organ chamber 110. FIG. 1 illustrates that the controller 180 can be connected to one or more components, sensors 188, and/or actuators 190 of the system 100. In this manner, the controller 180 can determine changes in conditions in the organ 112 and/or the fluid circuit 120 and respond to make adjustments to implement a particular perfusion protocol.

The sensors 188 can be any sensor used to monitor fluid flow and/or other characteristics for the system 100. Examples of sensors 188 include, but are not limited to, a weight sensor, a flow rate sensor, a temperature sensor, a flow pressure sensor, a timer, a valve state sensor, an electrocardiogram (ECG) sensor, a carbon dioxide sensor, a pH sensor, a potassium sensor (K+), a total hemoglobin sensor (Hb), a hematocrit sensor (Hct), an oxygen saturation (SO2) sensor, a partial pressure of oxygen (pO2) sensor, a partial pressure of carbon dioxide (pCO2) sensor, a lactate sensor, a glucose sensor, a tissue impedance sensor, an organ chamber volume sensor, and the like.

The actuators 190 can be any actuator used to perform an action that can impact perfusion of the one or more organs 112. Examples of actuators 190 include, but are not limited to, a switch, a controller, solenoid valves, pneumatic actuators, hydraulic actuators, motorized valves, piezoelectric actuators, dielectric elastomers, proportional control valves, linear actuators, rotary actuators, diaphragm actuators, thermal actuators, software drivers, and the like.

In the illustrated embodiment, the controller 180 is coupled to a user interface 194. The controller 180 can be connected to the user interface 194 using a wired or wireless connection. The user interface 194 enables a user 196 to interact with the controller 180 and to monitor and/or change operation of the fluid circuit 120 for perfusion by the system 100.

One of many aspects of the fluid circuit 120 that can be controlled by the controller 180 is a rate of supplying filtrate replacement fluid 160 to the perfusate 124. Similarly, the controller 180 can also control a rate of removing ultrafiltrate 150 from the perfusate 124. Of course, the controller 180 can control or modulate a rate of both supplying filtrate replacement fluid 160 and removing ultrafiltrate 150 from the perfusate 124. As explained above, the hemofilter 140 may remove ultrafiltrate 150 at a faster rate than desired or required. The controller 180 can control the revolutions per minute of the ultrafiltrate pump 148 to manage the rate of ultrafiltrate 150 removal. Similarly, or in addition, the controller 180 can control a valve (or a pump or other actuator 190) coupled to a filtrate replacement fluid supply 186 to manage a rate of introducing or supplying filtrate replacement fluid 160 to the perfusate 124.

Advantageously, the controller 180 has precise control and management of a filtrate replacement fluid 160 concentration and/or ultrafiltrate 150 concentration in the perfusate 124. This can facilitate maintaining a desired composition and/or concentration for effective and long-lasting perfusion that ensures long term viability of the organ 112.

In one embodiment, the controller 180 manages filtrate replacement fluid 160 supply and/or ultrafiltrate 150 removal from the perfusate 124 based on a measured parameter. The measured parameter represents a characteristic of one or more of the fluid circuit 120 and/or an organ 112 (or a plurality of organ 112 where the system 100 perfuses a plurality of organ 112).

In one embodiment, the controller 180 can operate as a control system for the system 100. The sensors 188 assist the controller 180 in gathering data for one or more measured parameters in the system 100. Those of skill in the art will appreciate that management of filtrate replacement fluid 160 supply and/or ultrafiltrate 150 removal can be based on a variety of measured parameters of either the organ 112, the fluid circuit 120, or both the organ 112 and the fluid circuit 120.

In one embodiment, the controller 180 modulates the composition of the perfusate 124 (e.g., filtrate replacement fluid 160 versus ultrafiltrate 150) in relation to a metabolic rate of the organ 112. The metabolic rate can be determined and/or estimated based on readings from sensors 188 that capture such information as: Oxygen consumption, mixed venous oxygen saturation (SVO2), lactate production, glucose levels, weight of the organ 112, heart rate where the organ 112 is a heart, stroke work in working mode where the organ 112 is a heart, and the like. Of course, the methods for monitoring metabolic rate can differ depending on the type of organ being perfused.

In one embodiment, the controller 180 can control the hemofilter 140, ultrafiltrate pump 148, and/or one or more actuators 190 for the filtrate replacement fluid supply 186 to concentrate plasma in the perfusate 124 by removing more liquid than the amount of liquid replaced by the filtrate replacement fluid 160. Such an adjustment can be used to increase a hematocrit to compensate for hemolysis and preserve an oxygen carrying capacity per volume of the perfusate 124. In one embodiment, the controller 180 can also make this adjustment to control perfusate osmolarity.

Alternatively, or in addition, in one embodiment, the controller 180 can use pressure sensors 188, within the fluid circuit 120, before and/or after any filters in the fluid circuit 120, before and/or after the hemofilter 140 and/or between the hemofilter 140 and the ultrafiltrate collector 152. These sensors 188 can indicate to the controller 180 when clotting and/or clogging of filters and/or the hemofilter 140 is occurring. Accordingly, the controller 180 can adjust operation of the hemofilter 140 to compensate for the clogging and/or clotting, or signal an operator to assist by replacing a filter or membrane of the hemofilter 140.

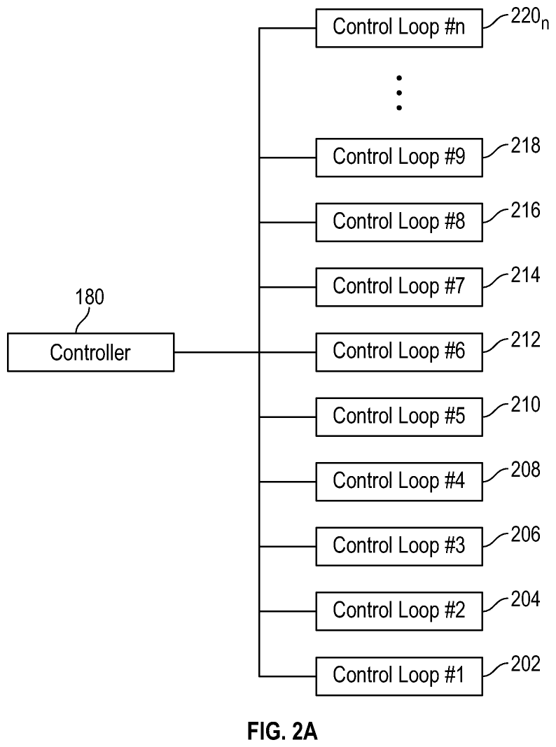

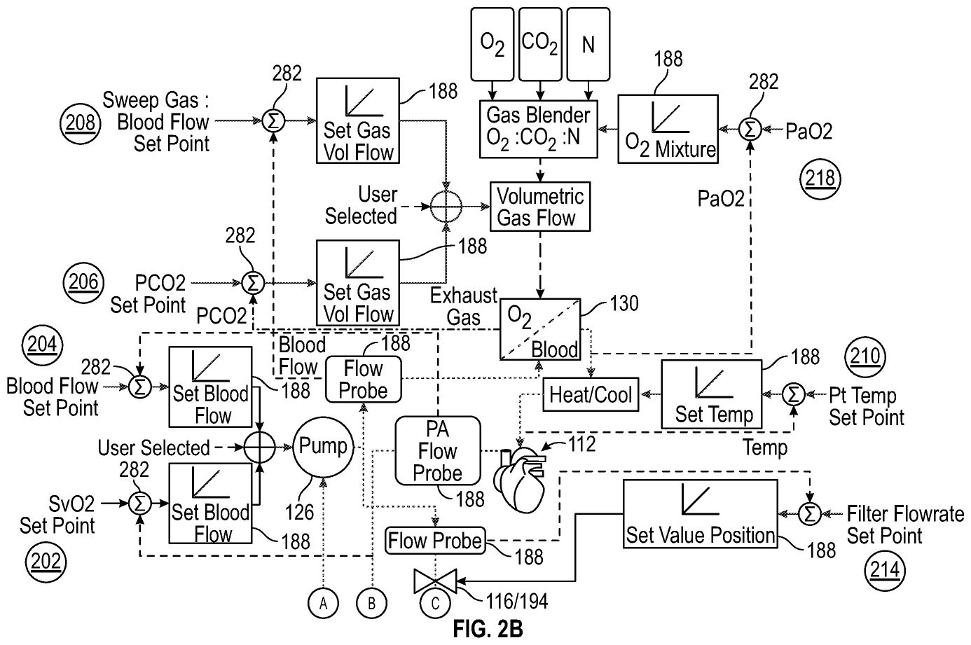

FIG. 2A is a block diagram depicting control loops for exemplary system for perfusing an organ, according to one embodiment. In certain embodiments, a perfusion system according to the present disclosure can include a control system, a processor, a controller 180 or other logic device configured to operate and/or monitor a system of components according to a perfusion protocol. In certain embodiments, the perfusion protocol is represented by a data structure that is configured to be understood by the controller 180 and that can be implemented using the components of the perfusion system and one or more control loops.

Referring back to FIG. 1, in one aspect, perfusion protocols can be characterized by specific system configurations for an organ selected for perfusion, the organ type's perfusion mode as well as perfusion parameter values, perfusion parameter control methods, controller tuning parameter values, alarm and alert criteria and threshold values. Perfusion protocols can be further defined by one, or a sequence of perfusion modes linked to form a sequence of actions.

In one example, upon system 100 power up, a user can be prompted to select the organ type to be perfused. Software of the controller 180 or a control system configures the system components and assigns functionality specific to support the organ type. This configuration can include display information and controls, valve assignments for fluid routing, pressure sensor assignments, alert and alarm conditions and levels, and saved default values for perfusion parameters and/or system settings.

In one embodiment, the system 100 can have three primary operating modes: set-up or priming, manual operation mode, and automated operation mode. For each of these modes, perfusion parameters and their control methods can be configurable specifically for each of the organ types or combination of organs to be perfused. Additionally, multiple configurations may be stored for recall and execution for a given organ type.

Priming operating mode is intended to facilitate set-up of an extracorporeal loop (e.g., fluid circuit 120) and any ancillary components in anticipation of attaching an organ for perfusion. This mode allows an operator to manipulate the system 100 without triggering unwanted alerts and alarms and can be used to execute either manually or by automatic means, specific set-up activities such as filling the circuit with fluid, deairing the circuit and its components, preheating or precooling the perfusate, maintaining target perfusate temperature, preconditioning the perfusate to target levels for oxygen content, pH, osmotic balance, blood gasses, blood chemistry, hematocrit, etc. Once set-up is complete, fluid (e.g., perfusate 124) may be recirculated in the extracorporeal loop to maintain conditioning and in the case of blood based perfusate to prevent clotting.

Manual operation mode allows an operator to establish and manage the perfusion by directly manipulating one or more of the controlled perfusion parameters and/or their control methods (e.g., control loops). Examples of the controlled perfusion parameters include perfusate flowrate, hemofilter perfusate flowrate, filtrate withdrawal rate, filtrate withdrawal volume target, filtrate replacement rate, sweep gas mixture and sweep gas flowrate, perfusate temperature, perfusate supplement administration, alarm and alerts threshold values, and the like. Additional parameters such as ventilation volume and ventilation rate for lung perfusion may be available as appropriate.

For example, when selecting Langendorf perfusion mode of a heart, perfusate flow to the organ may be controlled manually by directly adjusting a pump RPM value for the pump 126, or by selecting an automatic method such as for example set-point, closed-loop control based on one or more of the following measured parameters; arterial flow, aortic pressure, pulmonary artery flow, O2 utilization, or venous O2 saturation.

Similarly, an operator or a perfusion protocol may define or select individual control methods for perfusion parameters such as oxygenator sweep gas mixture (manual, pO2 set-point), sweep gas volumetric flowrate (manual, ratio metric to perfusate flow, exhaust gas CO2 set-point, pH), hemofilter perfusate flowrate (manual, automatic set-point), filtrate withdrawal rate (manual, organ weight based set-point, lactate level set point, automatically adjusted rate based on other measures of metabolic rate of the organ), filtrate replacement fluid flowrate (manual, a ratio metric in relation to filtrate withdrawal rate), perfusate supplementation and or drug delivery (manual or automatic based on metabolic rate or other measured values), and so forth.

In certain embodiments, manual operation mode can be of particular value during attachment, resuscitation, and/or stabilization of an ex-vivo organ. This period can be characterized by starting and stopping of perfusate flow, adjustments of perfusion parameters in response to observed organ behavior, titration of drug administrations, and in the case of heart perfusion, use of defibrillation and establishment of pacing.

In one embodiment, manual operation mode can be used throughout the ex vivo perfusion period to support on-going recovery, preservation, and/or assessment of a perfused organ by selecting various perfusion modes and perfusion parameter values and control methods as deemed appropriate.

Once a perfusion organ is established on the system 100, a controller 180 can implement an automated operation mode which can allow a user 196 to manage perfusion through selection of a single or a series of preprogrammed perfusion modes with specific perfusion parameter values and parameter control modes predefined and executed by the controller 180 and/or operating system software for a control system. Set up and storage of perfusion protocols can be done through the system display (e.g., user interface 194) or uploaded through system software updates.

In one embodiment, perfusion protocols are organ specific. Stored perfusion protocols for the organ type can be displayed on the user interface 194 following system power up and selection of the organ type to be perfused. Multiple perfusion protocols may be stored for a given organ type.

In one embodiment, for a given perfusion protocol, multiple perfusion modes can be selected and linked together to execute sequentially with time based and/or event driven transitions. Within each sequence, the perfusion mode parameters can be defined and/or adjusted by the operator 196, including target parameter values, parameter control methods, as well as alert and alarm values and/or sequence transition methods. Transitions between perfusion modes in a sequence may occur automatically based on time passage and/or other sensed conditions and/or through operator intervention. Perfusion modes may progress in sequence and/or loop back to earlier perfusion modes as defined by the operator 196 and/or a condition occurring in the system 100.

In one example perfusion protocol, a perfusion protocol for normothermic perfusion of a heart from a brain-dead donor (BDD) might, for example, contain the following sequence of perfusion modes:

Sequence 1) Langendorff perfusion mode, 0.7 ml/min/g of cardiac tissue w/set-point flow control based on pulmonary artery flow; 50% Oxygen, 45% Nitrogen, 5% CO2 sweep gas, sweep gas flow controlled to maintain pCO2 target of 40 mmHg as estimated by oxygenator exhaust gas analysis; No hemofiltration; No supplementation; temperature 37 C; Arterial pressure alarm limit: 90 mmHg; time based transition 60 minutes.

Sequence 2) Continued per sequence 1, with bulk perfusate change out (e.g., replaceable reservoir 128 and/or bulk perfusate diversion system) either operator initiated or automatic, hemofiltration at 150 ml/min perfusate flow thru hemofilter, 1 ml/hr/g of cardiac tissue filtrate withdrawal rate, filtrate replacement fluid at 1:1 ratio to withdrawal; time-based transition 4 hours.

Sequence 3) Left atrial working mode perfusion; left atrial flowrate set-point control to 2000 ml/min, filtrate withdrawal rate increased based on metabolic demand of organ as evidenced by oxygen utilization, filtrate replacement increased to match withdrawal, supplementation increased in proportion to metabolic demand. Assessment of organ performance made by analysis of ventricular P-V loop, end systolic pressure, systolic pressure rise time. Time based transition at 30 minutes;

Sequence 4) Langendorff perfusion mode, 0.7 ml/min/g of cardiac tissue weight w/set-point flow control based on pulmonary artery flow; 50% Oxygen, 45% Nitrogen, 5% CO2 sweep gas, sweep gas flow controlled to maintain pCO2 target of 40 mmHg as estimated by oxygenator exhaust gas analysis; hemofiltration at 150 cc/min perfusate flow thru hemofilter, 1 ml/hr/g of cardiac tissue filtrate withdrawal rate, filtrate replacement fluid at 1:1 ratio to withdrawal; time based transition 4 hours.

Sequence 5) Continued per sequence 4, with bulk perfusate change out (e.g., replaceable reservoir 128 and/or bulk perfusate diversion system) either operator initiated or automatic, event-based transition upon completion of perfusate bulk change out.

Sequence 6) Loop back to sequence 3. Operator initiated ending of the perfusion process.

Referring now to FIG. 2A, in one embodiment, the system 100 is managed by a plurality of control loops that can be part of a control system. The control loops can each be specifically designed to manage one aspect of the over system 100. FIG. 2B is a block diagram depicting example control loops for an exemplary system for perfusing a heart, according to one embodiment. The control loops of FIG. 2A are illustrated with examples in FIG. 2B.

Those of skill in the art will appreciate that the system 100 may include any number of control loops (#1-#n). The number of control loops can depend on the number of subsystems, subprocesses, modules, and/or components that make up the system 100. In one example, the system 100 may include as many as nine separate control loops. In certain embodiments, the control loops are open loop control loops. In other embodiments, the control loops are closed loop control loops. In another embodiment, the control loops are a combination of closed loop control loops and open loop control loops.

In one example embodiment, the system 100 may be perfusing a heart (e.g., organ 112). The system 100 may include a control loop #1 202 configured to manage and/or regulate perfusate 124 flow through a pulmonary artery (PA) in relation to a mixed venous oxygen saturation (SVO2). FIG. 2B illustrates control loop #1 202. In the example control loop #1 202, the control loop #1 202 includes a blood flow rate sensor 188 that measures blood flow rate in relation to a set point and a comparator 282 that compares the measured blood flow rate to the set point and provides feedback to the controller 180 for a possible adjustment.

A control loop #2 204 is configured to manage and/or regulate perfusate 124 flow through the fluid circuit 120. FIG. 2B illustrates control loop #2 204. In the example control loop #2 204, the control loop #2 204 includes a blood flow rate sensor 188 that measures blood flow rate in relation to a set point and a comparator 282 that compares the measured blood flow rate to the set point and provides feedback to the controller 180 for a possible adjustment.

A control loop #3 206 is configured to manage the CO2 content of the oxygenated perfusate (as represented by the oxygenator exhaust gas pCO2 or content which is assumed to be in equilibrium with the perfusate pCO2) by regulation of the sweep gas flowrate through the oxygenator. FIG. 2B illustrates control loop #3 206. In the example control loop #3 206, the control loop #3 206 includes a CO2 gas sensor (not shown) that measures the CO2 content (pCO2) in the exhaust gas stream of the oxygenator in relation to a set point and a comparator 282 that compares the measured gas concentration to the set point and provides feedback to the controller 180 for a possible adjustment of the oxygenator sweep gas volumetric flowrate.

A control loop #4 208 is configured to manage and/or regulate sweep gas as a ratio to the blood flow through the oxygenator. FIG. 2B illustrates control loop #4 208. In the example control loop #4 208, the control loop #4 208 includes a blood flow rate sensor 188 that measures blood flow rate in relation to the sweep gas flowrate and a comparator 282 that compares the measured ratio of blood flow to sweep gas flowrate to the set point and provides feedback to the controller 180 for a possible adjustment of the sweep gas flowrate.

A control loop #5 210 is configured to manage and/or regulate the temperature of the perfusate 124 in the fluid circuit 120. FIG. 2B illustrates control loop #5 210. In the example control loop #5 210, the control loop #5 210 includes a temperature sensor 188 that measures perfusate 124 temperature in relation to a set point and a comparator 282 that compares the temperature to the set point and provides feedback to the controller 180 for a possible adjustment.

A control loop #6 212 is configured to manage and/or regulate ultrafiltrate 150 flow out of the fluid circuit 120. FIG. 2B illustrates control loop #6 212. In the example control loop #6 212, the control loop #6 212 includes an ultrafiltrate 150 rate sensor 188 that measures ultrafiltrate 150 flow rate in relation to a set point and a comparator 282 that compares the measured ultrafiltrate 150 flow rate to the set point and provides feedback to the controller 180 for a possible adjustment.

In the illustrated embodiment, the system 100 includes a filter 250, such as a bulk media filter, that filters perfusate 124 before the perfusate 124 enters the reservoir 128. A control loop #7 214 is configured to manage and/or regulate perfusate 124 flow through the filter 250. FIG. 2B illustrates control loop #7 214. In the example control loop #7 214, the control loop #7 214 includes a perfusate 124 rate sensor 188 that measures perfusate 124 flow rate in relation to a set point and a comparator 282 that compares the measured perfusate 124 flow rate to the set point and provides feedback to the controller 180 for a possible adjustment.

A control loop #8 216 is configured to manage and/or regulate filtrate replacement fluid 160 flow into the fluid circuit 120 (e.g., by way of the reservoir 128). FIG. 2B illustrates control loop #8 218. In the example control loop #8 218, the control loop #8 218 includes a filtrate replacement fluid 160 flow rate sensor 188 that measures filtrate replacement fluid 160 flow rate in relation to a set point and a comparator 282 that compares the measured filtrate replacement fluid 160 flow rate to the set point and provides feedback to the controller 180 for a possible adjustment.

A control loop #9 218 is configured to manage and/or regulate partial pressure of arterial oxygen (PaO2) within the fluid circuit 120. FIG. 2B illustrates control loop #9 218. In the example control loop #9 218, the control loop #9 218 includes a pO2 sensor 188 that measures an oxygen partial pressure in relation to a set point and a comparator 282 that compares the measured oxygen partial pressure to the set point and provides feedback to the controller 180 for a possible adjustment of the 02 mixture ratio of sweep gas.

FIG. 2A includes control loop #n 220 which represents another control loop that may be added to the system 100 depending on the number of organs 112, number of fluid circuits 120, or any other parameter the system 100 is controlling.

Referring now to FIGS. 1, 2A, 2B, in one embodiment, the user interface 194 is configured to display information to a user 196 (e.g., operator). The user interface 194 also accepts input data from the user 196 for perfusion parameters. For example, a user can set or adjust a set point for one or more of the control loops being managed by the controller 180.

In one embodiment, a user 196 may operate one or more of the control loops in a manual operation mode. When operating the control loop in the manual operation mode, the user may provide user input to the user interface 194 which is conveyed to the controller 180 for execution of the manual operation mode. As explained above, perfusion may include a priming operating mode, a setup mode, or the like. During such modes of operation, a user 196 can operate one or more, or all of the control loops in a manual operation mode. This can be helpful for a user 196 as they apply their expertise to getting a donated organ perfused most effectively.

In certain embodiments, the control loops may operate based on one or more control parameter values, such as for example perfusion parameters. For example, one or more control loops may use a feedback control loop process for managing the control loop. For example, a proportional, integral, derivative (PID) form of process control may be used. Advantageously, a user 196 can adjust, set, or change coefficients used in the PID process controls for the controller 180.

Advantageously, the controller 180 is configured to transition a control loop from manual operation mode to automated operation mode in response to user input from a user 196 (e.g., operator). This can help the operator because the operator can focus on one or more control loops and get the perfusion parameters/setting set to optimal values and then signal to the controller 180 that a particular control loop can now transition from manual operation mode to automated operation mode.

Alternatively, or in addition, all the control loops can initially be operated by the controller 180 and a user 196 can selectively transition a control loop from automated operation mode to manual operation mode. In this manner, a user 196 can address a single control loop while the controller 180 handles one or more others control loops. Those of skill in the art will appreciate that any number of control loops can operate in a manual operation mode and/or an automated operation mode and then transition from one mode to another, either in response to user input, passage of time, and/or another event within the system 100.

In one embodiment, a perfusion protocol includes a plurality of perfusion parameters. The controller 180 is configured to modulate the plurality of perfusion parameters of the fluid circuit 120 to perfuse the organ 112 based on the perfusion protocol. In one embodiment, the controller 180 can modulate the perfusion parameters by way of one or more of a plurality of control loops.

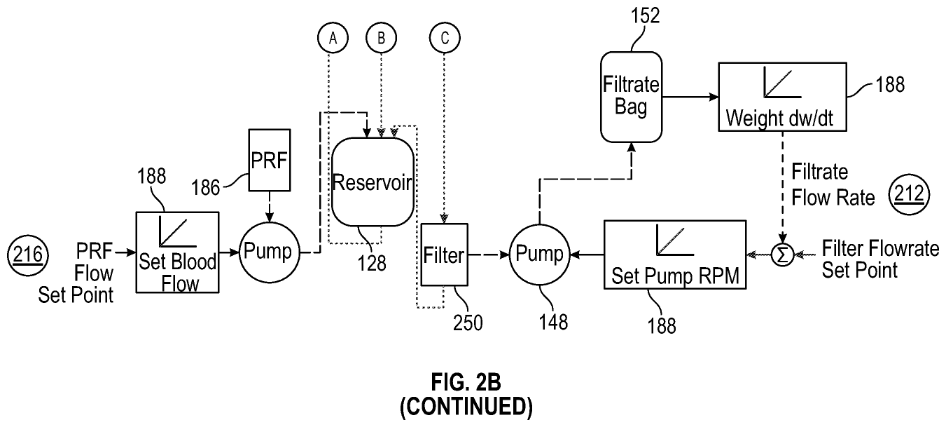

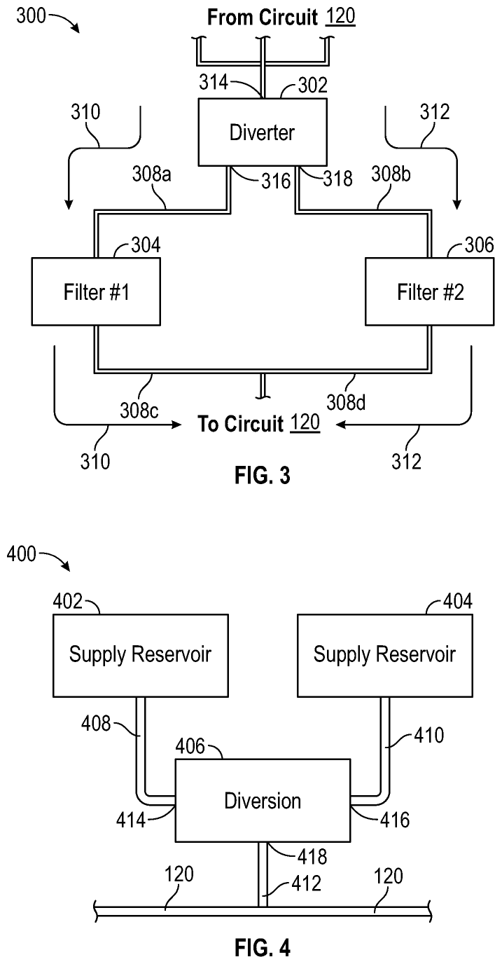

FIG. 3 is a block diagram depicting an exemplary diversion system 300 for diverting a fluid, according to one embodiment. The diversion system 300 includes a diverter 302, a first filter 304, a second filter 306, and interconnects 308. The diverter 302 serves to divert a fluid flow from a first path 310 to a second path 312. In one embodiment, the diverter 302 serves to divert at least a portion of a fluid flow from a first filter 304 to a second filter 306.

Advantageously, the diversion system 300 is configured to divert, redirect, and/or change in part or in whole a flow of a fluid from a first path 310 to a second path 312 without interrupting, stopping, or blocking a flow of fluid through a fluid circuit 120. Said another way, the diversion system 300 is configured to divert a continuous flow of fluid such that the flow remains continuous or substantially continuous as the diversion system 300 is in use, is active, and/or is transitioning from one state to another state. It should be noted that in certain embodiments, the diversion system 300 is configured to divert some or all of a fluid from first path 310 to a second path 312 without interrupting the fluid flow, such as a perfusion process perfusate 124 flow. For example, in one embodiment, the diversion system 300 can divert fluid from first filter 304 and back into the fluid circuit 120 such that a perfusion flow is not interrupted, but some quantity of fluid is not filtered.

Alternatively, or in addition, the diversion system 300 is configured to divert some or all of a fluid from first filter 304 to a second filter 306 without interrupting filtration of the fluid. In this manner, the diversion system 300 may divert a fluid flow and not interrupt the fluid flow and not interrupt the fluid filtration. Fluid filtration can impact efficacy of a fluid flow process such as perfusion such that longer term viability of an organ can be achieved.

A diverter 302 can be very simple or more complex. For example, in one embodiment, a diverter 302 can include a simple “Y” connector that joins a fluid circuit 120 at a single inlet port 314 and the first filter 304 to a first outlet port 316 and the second filter 306 to a second outlet port 318. Such a diverter 302 can include a clamp, such as a surgical clamp and/or a valve on the interconnects 308 to the first filter 304 and second filter 306. An operator may operate the diverter 302 by closing a clamp or valve on an interconnect 308 to a first filter 304 and opening a clamp or valve on an interconnect 308 to a second filter 306. In this manner, an operator may activate the diverter 302 and divert fluid from the first filter 304 to the second filter 306.

In one embodiment, the diverter 302 is a single mechanical device with an inlet port 314, a first outlet port 316, and a second outlet port 318. For example, the diverter 302 may be a ball valve and/or a switch that includes, or is coupled to, the inlet port 314, the first outlet port 316, and the second outlet port 318.

An interconnect 308 is a structure configured to convey a fluid from a source to a destination. Those of skill in the art will appreciate that an interconnect 308 can be embodied in a variety of shapes, devices, structures, and/or configurations. In one embodiment, an interconnect 308 is tubing. In another embodiment, an interconnect 308 is a channel or passage or opening in a structure. Alternatively, or in addition, an interconnect 308 is a pipe. In the illustrated embodiment, the diversion system 300 includes interconnect 308a and interconnect 308b that connect the first outlet port 316 to first filter 304 and the second outlet port 318 to second filter 306. In certain embodiments, the diversion system 300 can also include interconnect 308c that connects an outlet port of first filter 304 to the fluid circuit 120 and an interconnect 308d that connects an outlet port of second filter 306 to the fluid circuit 120.

The first filter 304 is a filter for removing unwanted material from a fluid. The second filter 306 is a filter for removing unwanted material from a fluid. The diversion system 300 is configured to divert a fluid flow from a first path 310 through the first filter 304 to a second path 312 through the second filter 306. In one embodiment, the first filter 304 is a different type, style, size, and/or configuration of filter from the second filter 306 meaning that each filter may use a different filtering technique, technology, filter media, etc. In another embodiment, the first filter 304 and the second filter 306 are the same type, style, size, and/or configuration of filter. For example, the filter technology, filter shape, filter configuration, and/or filter media for the first filter 304 may be identical to the filter media for the second filter 306.

In one embodiment, there can be advantages to having the first filter 304 be the same type, technology and/or configuration as the second filter 306. For example, the first filter 304 and second filter 306 may be used in a perfusion system (e.g., system 100). Having the first filter 304 and second filter 306 be the same type and configuration prevents introducing further variations into the system that could impact the effectiveness and/or duration of perfusion that can be achieved and still maintain a viable organ 112.

Alternatively, or in addition, having the first filter 304 be identical to the second filter 306 can enable a transfer or diversion of fluid from the first filter 304 to the second filter 306 without disrupting a process that uses the fluid such as a perfusion process. Certain processes such as a perfusion process can be sensitive to an interruption in flow.

In one embodiment, the filter media of first filter 304 and second filter 306 can be replaceable. Advantageously, a controller 180 or an operator can activate the diverter 302 and divert all, or a part of, the flow of fluid from the first filter 304 (e.g., first path 310) to the second filter 306 (e.g., second path 312). If a user or controller 180 determines that filter media of a first filter 304 needs to be changed, the controller 180 or user can activate the diverter 302 and direct all of the fluid to the second filter 306. With the fluid diverted, a user can then replace filter media of the first filter 304 and/or replace the whole filter 304. Once the filter media or filter is replaced a user can redirect the fluid from the second path 312 to the first path 310. Alternatively, or in addition, the second filter 306 may include suitable filter media and/or the second filter 306 may be a new filter and/or include new filter media, such that the fluid may continue in second path 312 until it is determined that the second filter 306 and/or filter media of second filter 306 should be changed. At this point the fluid flow is diverted using the diverter 302 from the second filter 306 to the first filter 304. In certain embodiments, the first filter 304 and second filter 306 and diverter 302 are configured to divert and filter perfusate 124.

FIG. 4 is a block diagram depicting an exemplary diversion system 400 for diverting a fluid, according to one embodiment. In one embodiment, the diversion system 400 can be used as part of or in place of the reservoir 128 of system 100. In the illustrated embodiment, the diversion system 400 includes a first supply reservoir 402, a second supply reservoir 404, and a bulk perfusate diversion system 406, and one or more fluid interconnects (e.g., first fluid interconnect 408, second fluid interconnect 410, third fluid interconnect 412). In the illustrated embodiment, the first fluid interconnect 408 provides a fluid connection between the first supply reservoir 402 and inlet port 414 of the bulk perfusate diversion system 406. The second fluid interconnect 410 provides a fluid connection between the second supply reservoir 404 and inlet port 416 of the bulk perfusate diversion system 406. The third fluid interconnect 412 provides a fluid connection between an outlet port 418 of the bulk perfusate diversion system 406 and the fluid circuit 120.

The first supply reservoir 402 is configured to be coupled to the fluid circuit 120. The second supply reservoir 404 is configured to be coupled to the fluid circuit 120. In the illustrated embodiment, the bulk perfusate diversion system 406 is configured to connect and/or couple fluid (e.g., perfusate 124) of the first supply reservoir 402 and/or the second supply reservoir 404 to the fluid circuit 120.

In one embodiment, the bulk perfusate diversion system 406 is configured to direct all fluid from one of the first supply reservoir 402 or the second supply reservoir 404 to the fluid circuit 120. In this manner, perfusate 124 in one of the first supply reservoir 402 or the second supply reservoir 404 can be used as a perfusate 124 supply while the other is not used for perfusion.

Advantageously, in certain embodiments, the diversion system 400 is configured to switch or exchange a supply of perfusate 124 from the first supply reservoir 402 to the second supply reservoir 404 instantaneously or substantially instantaneously. This can be an advantage because perfusate 124 in a first supply reservoir 402 may have a composition or make up that is adversely affecting a perfused organ 112. Switching instantaneously can provide perfusate 124 that helps stimulate, rehabilitate, and/or resuscitate a perfused organ 112.

Alternatively, or in addition, the diversion system 400 is configured to supply perfusate 124 from one or the other of the first supply reservoir 402 and the second supply reservoir 404 without interrupting a flow of perfusate 124 in the fluid circuit 120. Alternatively, the diversion system 400 can supply perfusate 124 during a natural relaxation and/or rest period during the perfusion of the organ 112.

As with the diverter 302, the bulk perfusate diversion system 406 can be implemented using a simple configuration and/or assembly or a more complex system and/or apparatus or device. For example, a set of clamps and/or valves can be used with a “Y” connector connected to implement the bulk perfusate diversion system 406. In another embodiment, the bulk perfusate diversion system 406 includes a set of valves and/or diverters that can be manually or automatically operated.

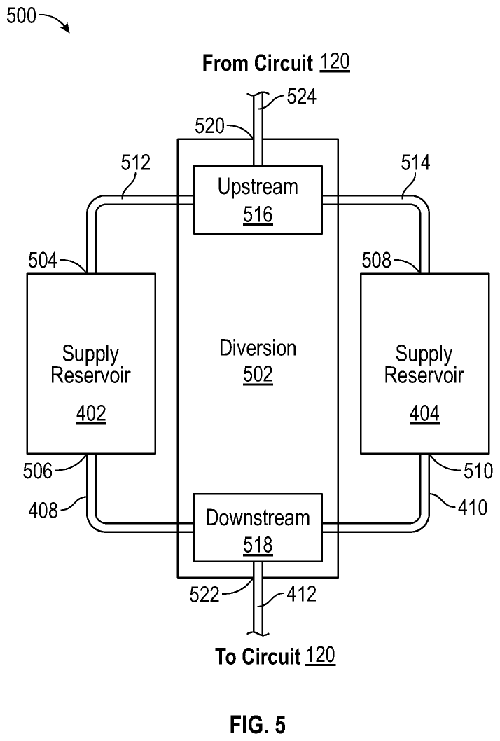

FIG. 5 is a block diagram depicting an exemplary diversion system 500 for diverting a fluid, according to one embodiment. The diversion system 500 may have many structures, features, and functions, operations, and configuration similar or identical to those of the diversion system 400 described in relation to FIG. 4, like parts are identified with the same reference numerals. Accordingly, the diversion system 500 may include a first supply reservoir 402, a second supply reservoir 404, a first fluid interconnect 408, a second fluid interconnect 410, and a third fluid interconnect 412.

The diversion system 500 includes a bulk perfusate diversion system 502. The diversion system 500 differs from the diversion system 400 because the diversion system 500 is configured to couple the first supply reservoir 402 to the fluid circuit 120 at both an inlet port 504 and at an outlet port 506. The diversion system 500 is also configured to couple the second supply reservoir 404 to the fluid circuit 120 at both an inlet port 508 and at an outlet port 510. In one embodiment, a fluid (e.g., perfusate 124) of the diversion system 500 flows into an inlet port 520 of the bulk perfusate diversion system 502 and out the outlet port 522 of the bulk perfusate diversion system 502. In certain embodiments, the fluid can flow through the first supply reservoir 402, or through the second supply reservoir 404, or through both the first supply reservoir 402 and the second supply reservoir 404 and out the outlet port 522. In one embodiment, the diversion system 500 is configured such that fluid from a fluid circuit flows only through either the first supply reservoir 402 or the second supply reservoir 404. In one embodiment, the diversion system 500 is configured to be oriented vertically such that gravity assists the flow of fluid from the inlet port 520 to the outlet port 522.

In the illustrated embodiment, the diversion system 500 includes a fourth fluid interconnect 512 and a fifth fluid interconnect 514. The fourth fluid interconnect 512 couples the inlet port 504 to the bulk perfusate diversion system 502 and the fifth fluid interconnect 514 couples the inlet port 508 to the bulk perfusate diversion system 502. The first fluid interconnect 408 couples the outlet port 506 to the bulk perfusate diversion system 502 and the second fluid interconnect 410 couples the outlet port 510 to the bulk perfusate diversion system 502.

In one embodiment, the bulk perfusate diversion system 502 is configured to couple one, or the other, or both, of the first supply reservoir 402 and the second supply reservoir 404 to the fluid circuit 120, both upstream (in the direction perfusate 124 flow is coming from) and downstream (in the direction perfusate 124 is flowing to).

In one embodiment, the bulk perfusate diversion system 502 includes an upstream diverter 516 and a downstream diverter 518. The upstream diverter 516 is configured to control whether perfusate 124 from the fluid circuit 120 flows into the first supply reservoir 402 or into the second supply reservoir 404. The downstream diverter 518 is configured to control whether perfusate 124 flows from the first supply reservoir 402 or the second supply reservoir 404 into the fluid circuit 120. In one embodiment, the upstream diverter 516 and/or downstream diverter 518 can be configured to enable perfusate 124 flow through both the first supply reservoir 402 and the second supply reservoir 404.

Those of skill in the art will appreciate that the upstream diverter 516 and/or the downstream diverter 518 can be a simple multiport valve, three-port valve, L-port valve, a “Y” connector and a set of clamps (e.g., surgical clamps or pinch clamps) coupled to one or more of an inlet fluid interconnect 524, the fourth fluid interconnect 512, fifth fluid interconnect 514, first fluid interconnect 408, second fluid interconnect 410, and/or the third fluid interconnect 412, or the like. Alternatively, or in addition, the upstream diverter 516 and/or the downstream diverter 518 can be pneumatic, solenoids, and/or electronically controllable by other means by for example the controller 180.

In the illustrated embodiment, the bulk perfusate diversion system 502 is configured to couple only one or the other of the first supply reservoir 402 and the second supply reservoir 404 to the fluid circuit 120 at any given time. Alternatively, or in addition, the bulk perfusate diversion system 502 can be configured to decouple either the first supply reservoir 402 or the second supply reservoir 404 from the fluid circuit 120, either alone or only when the other reservoir is coupled to the fluid circuit 120.

In the illustrated embodiment, the bulk perfusate diversion system 502 is configured to couple only one or the other of the first supply reservoir 402 and the second supply reservoir 404 to the fluid circuit 120. In this manner, the bulk perfusate diversion system 502 provides for an exchange of perfusate 124 in the fluid circuit 120. This exchange is referred to herein as a “bulk exchange” or “bulk perfusate change out.” Specifically, activation of the bulk perfusate diversion system 502 causes an exchange of perfusate 124 in a first supply reservoir 402 with perfusate 124 in a second supply reservoir 404. This bulk exchange provides a bulk removal of metabolic waste in the perfusate 124. For example, the bulk perfusate diversion system 502 enables the bulk exchange of the perfusate 124 of the fluid circuit 120 to remove, in bulk, metabolic waste from the fluid circuit 120. In one embodiment, the bulk perfusate diversion system 502 performs a bulk exchange of the perfusate 124 of the fluid circuit 120 within about thirty seconds. Thus, perfusion within the fluid circuit 120 may not be interrupted. In another embodiment, a perfusion system may employ a pump to perform a bulk exchange of perfusate. In one example, a pump may operate at 40 ml/min and exchange about 25% of a perfusate volume in the fluid circuit 120 in about 3.75 minutes (about 150 ml exchanged).

Said another way, the bulk perfusate diversion system 502 removes a bulk quantity of perfusate 124 from the fluid circuit 120 in a single operation/system (e.g., diversion system 500). This bulk exchange or replacement provides an effective and efficient removal of perfusate 124 that is carrying metabolic waste that is included in the perfusate 124 that is exchanged.

Suppose the diversion system 500 is operating in a system 100 and perfusion or priming is being performed on an organ 112. Initially, the perfusate 124 may flow through the first supply reservoir 402. For example, perfusion may be performed for an hour or so after the organ 112 is connected to the fluid circuit 120. This perfusate 124 flows through the first supply reservoir 402 which serves as a reservoir 128 in the system 100.

In one embodiment, the reservoir 128 is configured to hold between about 200 cc and about 600 cc of perfusate for perfusion of a heart organ. During a priming phase, without a reservoir 128, the fluid circuit 120 may hold about 200 cc of perfusate. In certain embodiments, the reservoir 128 is sized to hold more fluid than is needed for circulation in the fluid circuit 120 and/or more fluid than is being used in the fluid circuit 120. In this manner, the reservoir 128 can account for variations in the quantities used in the fluid circuit 120.

Next, an operator or the controller 180 can activate the bulk perfusate diversion system 502 and exchange the perfusate 124 in first supply reservoir 402 with perfusate 124 in second supply reservoir 404. Advantageously, the bulk perfusate diversion system 502 is configured to make this exchange without stopping or interrupting the perfusion of the organ 112, in other words perfusion of the organ 112 is continuous while perfusate 124 of first supply reservoir 402 is exchanged with perfusate 124 of second supply reservoir 404.

In one embodiment, the perfusate 124 of the second supply reservoir 404 that is exchanged or swapped into the fluid circuit 120 is of a greater quality for perfusion. In certain embodiments, this may mean the perfusate 124 in the second supply reservoir 404 has been filtered, cleaned, purified, or otherwise prepared for use in perfusion. In certain embodiments, the perfusate 124 in the second supply reservoir 404 is new, meaning that the perfusate 124 has not yet been used in a perfusion process. In certain embodiments, the perfusate 124 in the second supply reservoir 404 is a blood-derived fluid. In another embodiment, the perfusate 124 in the second supply reservoir 404 is a synthetic perfusate 124.

In still another embodiment, the perfusate 124 in the second supply reservoir 404 is a perfusate 124 that includes nutrients, drugs, or other additives for increasing the effectiveness and/or duration of perfusion. For example, the perfusate 124 in the second supply reservoir 404 may be supplemented or augmented with vitamins, nutrients, drugs, oxygen carriers, nutrient carriers, or the like.

In certain embodiments, the perfusate 124 of the second supply reservoir 404 that is exchanged or swapped into the fluid circuit 120 can be of a higher quantity than the quantity of perfusate 124 in the first supply reservoir 402. In this manner, the volume of perfusate 124 in the fluid circuit 120 can be adjusted up or down depending on the needs for effective and high duration perfusion of the organ 112.

In one embodiment, the diversion system 500 can swap or exchange perfusate 124 using the first supply reservoir 402 and/or the second supply reservoir 404 in a technique that can be referred to as a chasing technique. In certain embodiments, the diversion system 500 drives the perfusate 124 using gravity and/or a pump 126. In such an example embodiment, the second supply reservoir 404 may supply perfusate 124 (e.g., cleaned, new, processed, revitalized, conditioned, reconditioned, etc.) to the fluid circuit 120 while the first supply reservoir 402 collects perfusate 124 (e.g., old, contaminated, etc.) from the fluid circuit 120. This technique can be implemented by a user or controller opening the downstream diverter 518 and/or the outlet port 510 for the second supply reservoir 404 and closing the upstream diverter 516 and/or the inlet port 504 for the first supply reservoir 402. In this manner, the second supply reservoir 404 begins supplying perfusate 124 as the first supply reservoir 402 collects perfusate 124 from the fluid circuit 120.

Thus, perfusate 124 in the fluid circuit 120 is “chased” through the fluid circuit 120 by perfusate 124 from the second supply reservoir 404. This technique can be advantageous because perfusate 124 in components of the fluid circuit 120 gets moved out of the fluid circuit 120 (e.g., replaced). In certain embodiments, this technique changes almost all or almost 100% of the perfusate 124 in the fluid circuit 120. This technique in effect drains the “hold up volume” out of the fluid circuit components which is collected by the first supply reservoir 402 while simultaneously replacing the perfusate 124 in the components with perfusate 124 from the second supply reservoir 404. Of course, the first supply reservoir 402 and second supply reservoir 404 are configured to accommodate the quantity of perfusate 124 needed for this technique. Once the “hold up volume” of the fluid circuit 120 is transferred out of the fluid circuit 120 the perfusate 124 in the first supply reservoir 402 can be isolated by activating the upstream diverter 516 and/or closing the inlet port 504 to the first supply reservoir 402 and/or opening the inlet port 508 for the second supply reservoir 404. The outlet port 506 can remain closed and the outlet port 510 can remain open. Using this technique, the perfusate supply for the fluid circuit 120 is changed instantaneously after a short period of time needed to “chase” old perfusate 124 from the fluid circuit 120.

Alternatively, or in addition, the diversion system 500 can include a third reservoir that is a waste reservoir and the bulk perfusate diversion system 502 can divert perfusate 124 in the fluid circuit 120 to the waste reservoir as perfusate 124 is supplied to the fluid circuit 120 by the first supply reservoir 402 and/or the second supply reservoir 404.

Thus, the bulk perfusate diversion system 502 of the diversion system 500 enables a bulk removal of metabolic waste from the fluid circuit 120. The removal of this waste, in bulk and without interrupting perfusion, can greatly increase the length of time the organ 112 remains viable during perfusion. Tests have shown that a fluid circuit 120 that includes bulk perfusate exchange and hemofilter 140 of perfusate 124 can perfuse a heart for as many as forty-eight hours. Additionally, in addition to removing the metabolic waste, the bulk perfusate diversion system 502 is effective in removing drugs (e.g., a cardioplegic solution or other medications) or other fluids that may have been added to the circuit during priming and/or initial stages/phases of perfusion and circulating toxins resulting from the organ harvest, transport and or storage and or reperfusion.

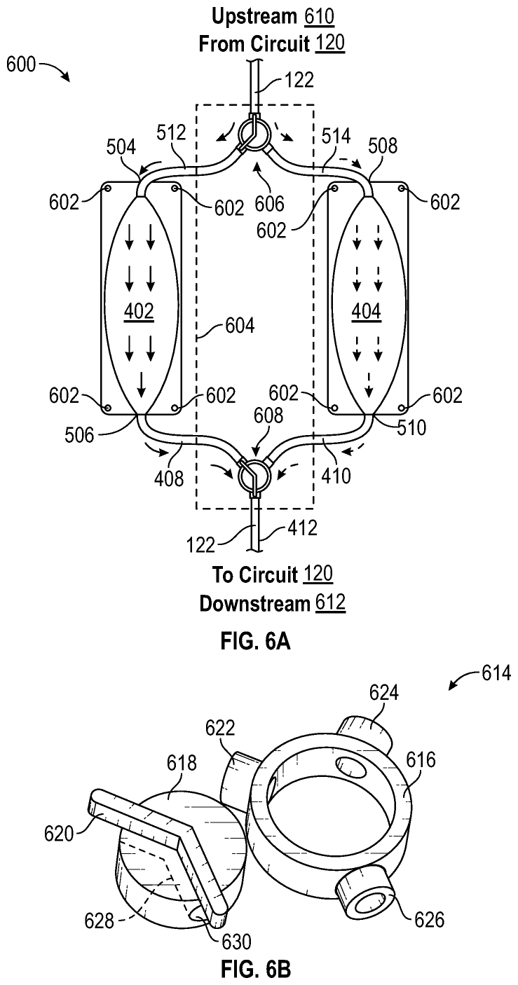

FIG. 6A illustrates an exemplary system 600 for diverting a fluid flow, according to one embodiment. In the illustrated embodiment, the system 600 can serve as a perfusate supply and/or reservoir (e.g., a replaceable reservoir) in a perfusion system. In certain embodiments, the system 600 is one example of an implementation of the diversion system 500 described in relation to FIG. 5. Accordingly, the system 600 includes components and systems that perform the same or substantially the same function as those similar components and systems of the diversion system 500. The system 600 may have many structures, features, and functions, operations, and configuration similar or identical to those of the diversion system 500 and/or diversion system 400 described in relation to FIG. 5, like parts are identified with the same reference numerals.

Accordingly, the system 600 may include a first supply reservoir 402, a second supply reservoir 404, a first fluid interconnect 408, a second fluid interconnect 410, and a third fluid interconnect 412. Also, the system 600 includes a fourth fluid interconnect 512, a fifth fluid interconnect 514, and an inlet fluid interconnect 524. The fluid interconnects can be flexible tubing. Similarly, the system 600 includes inlet port 504 (e.g., first reservoir inlet port), outlet port 506 (e.g., first reservoir outlet port), inlet port 508 (e.g., second reservoir inlet port), and outlet port 510 (e.g., second reservoir outlet port). Those of skill in the art will appreciate that the inlet ports and outlet ports can include a valve (manual or mechanical or electromechanical), clamp, or can be closed off using a hand surgical clamp.

In the system 600 of FIG. 6A, the first supply reservoir 402 and second supply reservoir 404 are of about the same size, shape, and/or configuration. Those of skill in the art will appreciate that the size, shape, and/or configuration of each of the first supply reservoir 402 and the second supply reservoir 404 can be different in different embodiments. In the illustrated embodiment, the first supply reservoir 402 and/or the second supply reservoir 404 can be a flexible and/or pliable plastic or other biocompatible material and may be a bladder, bag, soft shell bags, or the like. The first supply reservoir 402 and/or the second supply reservoir 404 can be reusable and/or disposable and sterile and sealed. In one embodiment, the first supply reservoir 402 and/or the second supply reservoir 404 are configured the same on opposite ends such that the reservoirs can be mounted in the system 600 with either end connected to upstream interconnects 512, 514, or to downstream interconnects 408, 410 respectively. In certain embodiments, the first supply reservoir 402 and/or the second supply reservoir 404 can include one or more openings 602 to facilitate hooking the first supply reservoir 402 and/or the second supply reservoir 404 to a weight sensor (not shown). Weighing the first supply reservoir 402 and/or the second supply reservoir 404 directly using the openings 602 mitigates sensor interferences from perturbations of the fluid interconnects.

Like the bulk perfusate diversion system 502, the system 600 includes a flow diversion system 604. The flow diversion system 604 is in fluid communication with the first supply reservoir 402, the second supply reservoir 404 and tubing 122 (both upstream and downstream) of the fluid circuit 120. The flow diversion system 604 facilitates a bulk exchange of perfusate 124 in the first supply reservoir 402 with perfusate 124 in the second supply reservoir 404. Like the bulk perfusate diversion system 502, the flow diversion system 604 includes an upstream diverter 516 embodied in this example as a mechanical inlet diverter 606 and a downstream diverter 518 embodied in this example as a mechanical outlet diverter 608.

Advantageously, the flow diversion system 604 implements a reservoir 128 as two separate reservoirs 402, 404 such that bulk quantities of perfusate 124 can be exchanged in a fluid circuit 120 without interrupting a perfusion procedure/process. This continuous perfusion coupled with an ability to exchange perfusate 124 in bulk enables the system 600 to provide enhanced, cleaned, and/or rehabilitated perfusate 124 to the fluid circuit 120 to extend the effectiveness and duration of perfusion to maintain a viable organ 112.

The diverters 606, 608 divert fluid, such as a perfusate 124 from a first path to a second path. Specifically, inlet diverter 606 is in fluid communication with tubing 122 on the upstream side 610 of the fluid circuit 120. The inlet diverter 606 is also in fluid communication with the inlet port 504 for the first supply reservoir 402 and the inlet port 508 for the second supply reservoir 404. In one setting of the inlet diverter 606, the inlet diverter 606 directs perfusate 124 from the tubing 122 into the first supply reservoir 402. Outlet diverter 608 is in fluid communication with tubing 122 on the downstream side 612 of the fluid circuit 120. The outlet diverter 608 is also in fluid communication with the outlet port 506 for the first supply reservoir 402 and the outlet port 510 for the second supply reservoir 404. In one setting of the outlet diverter 608, the outlet diverter 608 directs perfusate 124 from the first supply reservoir 402 into the tubing 122 on the downstream side 612 of the fluid circuit 120.

Those of skill in the art will appreciate that that the inlet diverter 606 and/or the outlet diverter 608 can be any diverter or diverter means that accomplishes the function of diverting flow from one path to another path. In certain embodiments, the inlet diverter 606 and/or outlet diverter 608 can be clamps (e.g., pinch clamps or hand surgical clamps) or valves, or diverter valves. Furthermore, the diverters used in embodiments of the present disclosure can be manual diverters, mechanical diverters, electromechanical diverters, pneumatic diverters, or the like that can be controlled by an operator, by a solenoid or a controller 180, or by both an operator and/or a controller 180.

In the illustrated embodiment, the inlet diverter 606 is configured to direct all of the fluid coming into the inlet diverter 606 from the tubing 122 into only one supply reservoir. The outlet diverter 608 is configured to direct all the fluid coming into the inlet diverter 606 from one of the supply reservoirs into the tubing 122. Accordingly, with the inlet diverter 606 in a first position, perfusate 124 flows into the first supply reservoir 402 from the tubing 122 and the outlet diverter 608 in a first position, perfusate 124 flows from the first supply reservoir 402 into the tubing 122. Activation of the inlet diverter 606 causes the inlet diverter 606 to redirect the perfusate 124 from the first reservoir inlet port 504 to the second reservoir inlet port 508. Activation of the outlet diverter 608 redirects a path or flow of the perfusate 124 from the first reservoir outlet port 506 to the second reservoir outlet port 510 such that perfusate of the first reservoir 402 is exchanged in the fluid circuit 120 with the perfusate of the second reservoir 404.

FIG. 6B illustrates one example embodiment of a diverter that can be used for the inlet diverter 606 and/or the outlet diverter 608. FIG. 6B is a perspective exploded view of an example diverter 614. The diverter 614 includes a housing 616, an inner body 618, and a handle 620. The housing 616 includes a first port 622, a second port 624, and a third port 626. The inner body 618 includes a passage 628 that includes a first opening 630 and a second opening (not shown) that extends through the inner body 618. The handle 620 extends from the inner body 618. Rotating the handle 620 rotates the inner body 618 within the housing 616. When the inner body 618 is in a first position, the openings 630 of the passage 628 align with the first port 622 and the third port 626. When the inner body 618 is in a second position, the openings 630 of the passage 628 align with the second port 624 and the third port 626. In this manner, the diverter 614 directs fluid from the first port 622 to the third port 626 in a first position and from the second port 624 to the third port 626 in a second position. Advantageously, the handle 620 can indicate the direction of fluid flow when the handle 620 and inner body 618 are in a respective first and second positions.

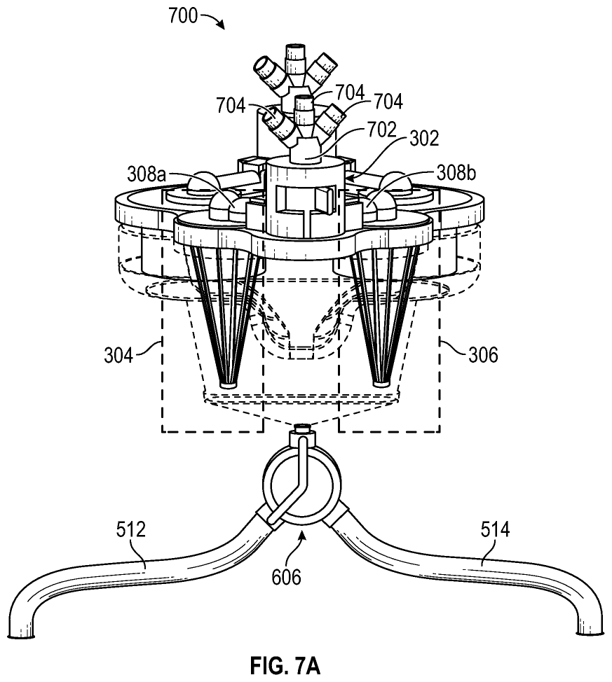

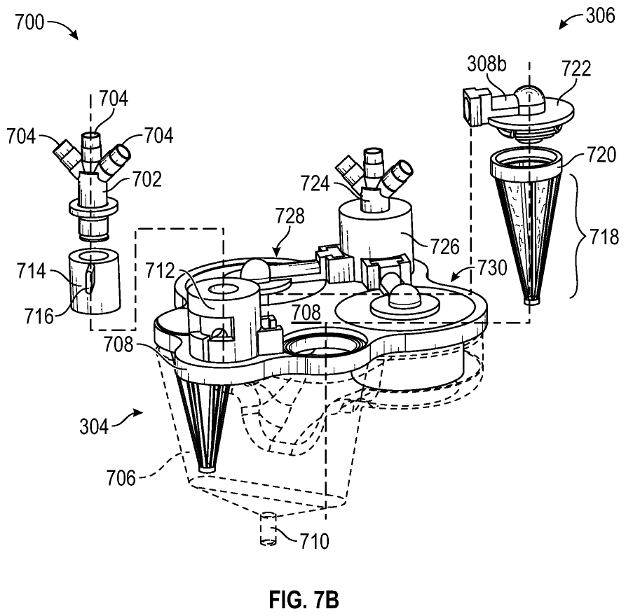

FIG. 7A illustrates an exemplary apparatus 700 for diverting a fluid flow, according to one embodiment. In one embodiment, the apparatus 700 can serve as part of a reservoir 128 for example in system 100. Alternatively, or in addition, the apparatus 700 can serve as part of a perfusate supply for an example perfusion system.

In the illustrated embodiment, the apparatus 700 is one example of the diversion system 300 described in relation to FIG. 3. Accordingly, the apparatus 700 may have many structures, features, and functions, operations, and configuration similar and/or identical to those of the diversion system 300 described in relation to FIG. 3, like parts are identified with the same reference numerals. Accordingly, the apparatus 700 includes a diverter 302, a first filter 304, a second filter 306, an interconnect 308a, and an interconnect 308b. Alternatively, or in addition, the apparatus 700 may be configured for use with the diversion system 500 and/or system 600. Accordingly, FIG. 7A illustrates an inlet diverter 606, fourth fluid interconnect 512, and fifth fluid interconnect 514.

In certain embodiments, the apparatus 700 is a filter diversion system that is coupled to at least one inlet port (e.g., a multi-port coupler 702) which is in fluid communication with a source such as tubing 122 for a fluid circuit 120. The inlet port (e.g., multi-port coupler 702) can include one or more inlets. In the illustrated embodiment, the inlet port has three inlets. Perfusion of different organs 112 may result in a plurality of tubing 122 that is connected between the organ 112 and the multi-port coupler 702. Advantageously, the multi-port coupler 702 can support the number of ports for a variety of organs 112. For example, for a heart, one of the inlet ports 704 can connect to interconnect or tubing coming from a pulmonary artery, one of the inlet ports 704 can connect to interconnect or tubing coming from an aorta, one of the inlet ports 704 can connect to interconnect or tubing coming from a left ventricle. Alternatively, or in addition, one of the inlet ports 704 can connect to interconnect or tubing coming from replacement fluid supply 186, one of the inlet ports 704 can connect to interconnect or tubing coming from a hemofilter 140.

Advantageously, with each of the different input sources of perfusate 124 and/or filtrate replacement fluid 160 to the multi-port coupler 702 filtration and/or perfusate 124 exchange can be performed using embodiments of the system 600 and/or apparatus 700 disclosed herein.

Alternatively, or in addition, the apparatus 700 can include a filter diverter, such as diverter 302, that diverts fluid for filtration from a first filter 304 to a second filter 306.

Advantageously, the diverter 302 is connected to, or coupled to, the multi-port coupler 702. The multi-port coupler 702 can be connected to a plurality of different tubing 122 that can come from a plurality of sources within the fluid circuit 120. In the illustrated embodiment, the multi-port coupler 702 includes three inlet ports 704. The inlet ports 704 direct perfusate 124 coming from upstream (e.g., from the tubing 122) into the diverter 302. The diverter 302 can be configured to direct the fluid to one of the filters 304, 306 or to both filters 304, 306 simultaneously.

In one embodiment, the diverter 302 is a filter diverter valve. FIG. 7B illustrates a perspective exploded view of the apparatus 700. The apparatus 700 includes a housing 706 (illustrate as transparent to show internals) and a top plate 708 connected to the diverter 302. The housing 706 houses both the first filter 304 and the second filter 306 and has an outlet port 710 that can connect to inlet diverter 606 or to an interconnect 308. In the illustrated embodiment, as fluid passes through either the first filter 304 or the second filter 306 the fluid then flows to the outlet port 710.

The diverter 302 can include a body 712 and a barrel switch/valve 714 that can include a handle 716. The body 712 can be connected to the top plate 708. The multi-port coupler 702 and barrel switch/valve 714 can include a coaxial passage that conveys fluid from the inlet ports 704. The barrel switch/valve 714 also includes an exit port (opposite the handle 716 in this embodiment). When the barrel switch/valve 714 is in one position the exit port aligns with a first interconnect 308a and when the barrel switch/valve 714 is in a second position the exit port aligns with a second interconnect 308b. In one embodiment, when the barrel switch/valve 714 is in between the first position and the second position, the exit port may align with both the interconnect 308a and the interconnect 308b. In certain embodiments, one may desire to place the barrel switch/valve 714 in between the first position and the second position to enable greater throughput of perfusate 124 with the perfusate 124 passing through both the first filter 304 and the second filter 306.

FIG. 7B illustrates the second filter 306 in an exploded view. The first filter 304 can be the same design, size, shape, and configuration as the second filter 306. Alternatively, or in addition, the first filter 304 and second filter 306 can have different designs, sizes, shapes, and configurations.

The second filter 306 can include a filter media 718, a filter holder 720, and a filter cap 722. The filter media 718 filters fluid passing through the second filter 306, the fluid enters the second filter 306 from the filter cap 722 (e.g., interconnect 308b) and passes through the filter media 718 before exiting the filter and the housing 706 through the outlet port 710. Air emboli, particulates and/or other unwanted materials in the perfusate 124 are caught by the filter media 718. In one embodiment, the filter media 718 can be a mesh screen. Advantageously, the filter media 718 can be replaced by removing the filter cap 722 and removing the filter media 718 from the filter holder 720 and inserting a new or rehabilitated filter media 718 into the filter holder 720. The filter holder 720 retains the filter media 718 during filtration. In one embodiment, both the filter media 718 and filter holder 720 can be removed and/or replaced for the second filter 306.

The filter cap 722 provides a fluid seal for the second filter 306, retains the filter holder 720 and filter media 718 and can include an integrated interconnect 308b for conveying the fluid to the filter 306.

Those of skill in the art will appreciate that the second filter 306 and first filter 304 can include the same components that are configured similarly such that the apparatus 700 provides two separate filters. Each filter can include a replaceable filter media 718. Advantageously, the apparatus 700 is configured to pass fluid through either or both filters 304, 306 without interrupting the flow of fluid in the fluid circuit 120. For example, an operator or user or in other embodiments a controller 180 can activate the diverter 302 and thereby divert perfusate 124 from a first filter 304 to a second filter 306 without stopping or interrupting a flow of perfusate 124 through the apparatus 700. With the fluid flow diverted and uninterrupted, a user can then replace the first filter media 718 in the first filter 304 while the perfusate 124 continues to be filtered by the second filter 306. In this manner, the apparatus 700 enables clogged or dirty filters to be replaced while filtration continues. In addition, the apparatus 700 enables a user to divert the fluid flow from first filter 304 to second filter 306 without interrupting or stopping perfusion of an organ 112.

In one embodiment, the diverter 302 can be referred to as a filter diverter and/or a filter diverter valve. As discussed, the diverter 302 can be configured to operate as a sequential diversion system meaning fluid flowing into the first filter 304 is diverted in sequence and completely from the first filter 304 to the second filter 306. Alternatively, or in addition, the diverter 302 can be configured to operate as a parallel diversion system meaning fluid flowing into the first filter 304 is diverted in parallel to both the first filter 304 and to the second filter 306. In certain embodiments, the parallel diversion system is configured to pass the fluid to both the first filter 304 and the second filter 306 in equal proportions. In another embodiment, the parallel diversion system is configured to pass the fluid to both the first filter 304 and the second filter 306 according to a ratio between zero and one hundred.

Those of skill in the art will appreciate that each of the inputs to a reservoir 128 can be connected to a multi-port coupler 702 and passed through one or both of the first filter 304 and the second filter 306. Alternatively, or in addition, FIG. 7B illustrates an alternative embodiment in which certain sources of perfusate 124 are coupled to the multi-port coupler 702 (e.g., for a perfused heart: from a left atrium, from a left ventricle, from replacement fluid supply 186, and/or from a hemofilter 140) and other sources of perfusate 124 can be connected to a second multi-port coupler 724.

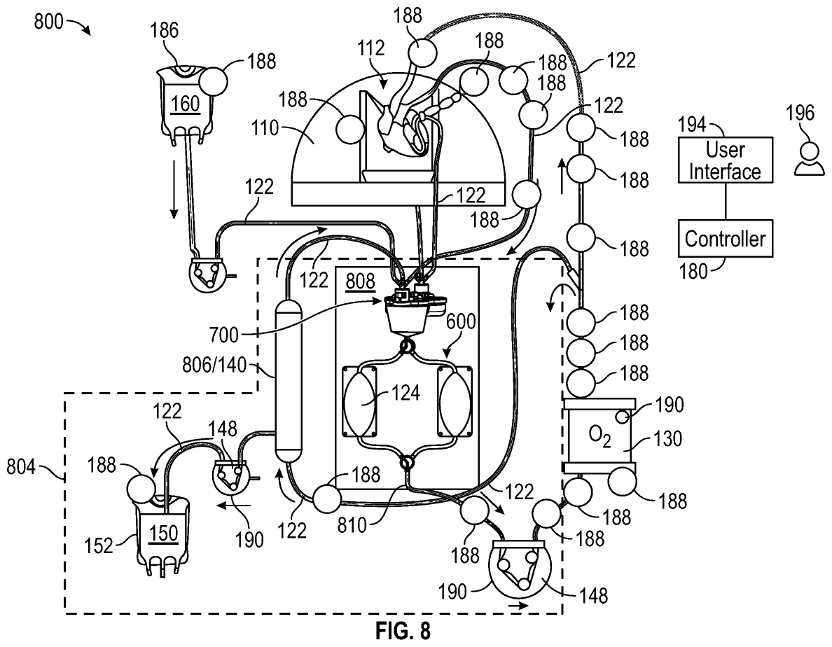

In the illustrated embodiment, the second multi-port coupler 724 is coupled to a second diverter 726. The second diverter 726 is coupled to a first defoamer 728 and a second defoamer 730. “Defoamer” refers to an apparatus, instrument, structure, member, device, component, system, or assembly structured, organized, configured, designed, arranged, or engineered to remove and/or mitigate the presence of foam or bubbles in a fluid. In certain embodiments, a defoamer can also include features that remove or eliminate particulates, debris, air bubbles and other bubbles in a fluid. In certain embodiments, a defoamer is a specialized filter that concentrates on the removal of bubbles and/or air in a fluid. One or more of the inlet ports of the second multi-port coupler 724 can be coupled tubing 122 of a fluid circuit 120. In certain embodiments, the connections to the second multi-port coupler 724 are for perfusate 124 from more secondary sources such as a drain line from an organ chamber 110, a drain line from one or more chambers in a perfused organ 112, and the like. If an inlet port is unused on the second multi-port coupler 724 and/or the multi-port coupler 702, the unused inlet port can be capped with a cap (See FIG. 8).

As with the first filter 304 and the second filter 306, the apparatus 700 provides a set of defoamers and a perfusate 124 flow can be diverted using the second diverter 726 between the first defoamer 728 and the second defoamer 730 without interrupting the defoaming of perfusate 124 and/or without interrupting perfusion within a fluid circuit 120. Furthermore, the apparatus 700 enables either the media of a first defoamer 728 to be changed while fluid flows through the second defoamer 730, or vice versa. Alternatively, or in addition, the second diverter 726 can pass the fluid through both the first defoamer 728 and the second defoamer 730 simultaneously.

FIG. 8 illustrates an exemplary system 800 for perfusing an organ, according to one embodiment. The system 800 may have many structures, features, and functions, operations, and configuration similar or identical to those of the system 100 described in relation to FIG. 1, like parts are identified with the same reference numerals. Accordingly, the system 800 may include an organ chamber 110 that houses a heart organ 112, tubing 122, an oxygenator 130, and a pump 148.

The system 800 includes an extracorporeal circuit 802 similar to the fluid circuit 120 of the system 100. In the illustrated embodiment, fluid flows within the extracorporeal circuit 802 in a counter-clockwise direction. In the illustrated embodiment, the pump 148 pumps perfusate 124 in a counter-clockwise direction. The oxygenator 130 exchanges oxygen gas for waste gas in the perfusate 124. The tubing 122 is used throughout the system 800. Those of skill in the art will appreciate that certain lengths of tubing can be replaced with passages in other structures within certain embodiments.

The system 800 also includes a perfusate supply 804. The perfusate supply 804 includes a hemofilter 806 similar to the hemofilter 140 of system 100 and a replaceable perfusate reservoir 808. The replaceable perfusate reservoir 808 can serve a similar function as the reservoir 128 of FIG. 1. In the illustrated embodiment, the replaceable perfusate reservoir 808 includes a system 600 and an apparatus 700 that are coupled together to serve as the replaceable perfusate reservoir 808.

Those of skill in the art will appreciate that that the replaceable aspects of the replaceable perfusate reservoir 808 can include one or more aspects of the system 600 of the apparatus 700 and/or a combination of these. For example, in this disclosure, the system 600 can include a replaceable first supply reservoir 402 and/or second supply reservoir 404. Similarly, the apparatus 700 includes replaceable filter media 718 of the first filter 304 and/or second filter 306. And/or in certain embodiments, the whole replaceable perfusate reservoir 808 can be replaceable.

As described herein, the perfusate supply 804 supplies revitalized perfusate 124 to the extracorporeal circuit 802 by way of tubing 122 connected to an outlet port 810 of the replaceable perfusate reservoir 808. Revitalized perfusate 124 can include perfusate that is filtered, that has received hemofiltration, is new unused perfusate, has had nutrients and/or additives added to the perfusate, has had supplements added to the perfusate, has had drugs added to the perfusate, has had nutrient carriers added to the perfusate, has had oxygen carriers added to the perfusate, and the like. Revitalized perfusate can also be referred to as enhanced perfusate and/or improved perfusate.

In the illustrated embodiment, the perfusate supply 804 includes a hemofilter 806, a replaceable perfusate reservoir 808, a pump 148, and a collector 152 for ultrafiltrate 150. However, in certain embodiments, the perfusate supply 804 can also include a replacement fluid supply 186 and its filtrate replacement fluid 160, and any accessories such as a pump.

As described with respect to the system 600 and/or the apparatus 700, the perfusate supply 804 is capable of providing revitalized perfusate continuously and/or intermittently depending on one or more factors including, but not limited to, a condition of the organ 112, changes in conditions in the system 800, passage of time, user input from a user 196, and the like. This flexibility enables the system 800 to supply perfusate in a manner that extends the viability of the organ 112 from a few hours to several days.

FIG. 8 illustrates that the system 800 includes a set of sensors 188 and/or a set of actuators 190. These are used to monitor perfusion parameters such that adjustments can be made as needed. The system 800 includes a controller 180, and a user interface 194. The controller 180 is coupled to the extracorporeal circuit 802 and configured to manage a plurality of perfusion parameters of the extracorporeal circuit 802 to effectively perfuse the organ 112. In the illustrated embodiment, the organ 112 is a heart. Consequently, the controller 180 is configured to implement a perfusion protocol. For example, the controller 180 may implement a perfusion protocol for “Langendorf” perfusion, working mode perfusion, working mode from a left side of the heart perfusion, working mode from a right side of the heart perfusion, low volume working mode perfusion, a combination of these in a sequence, or the like.

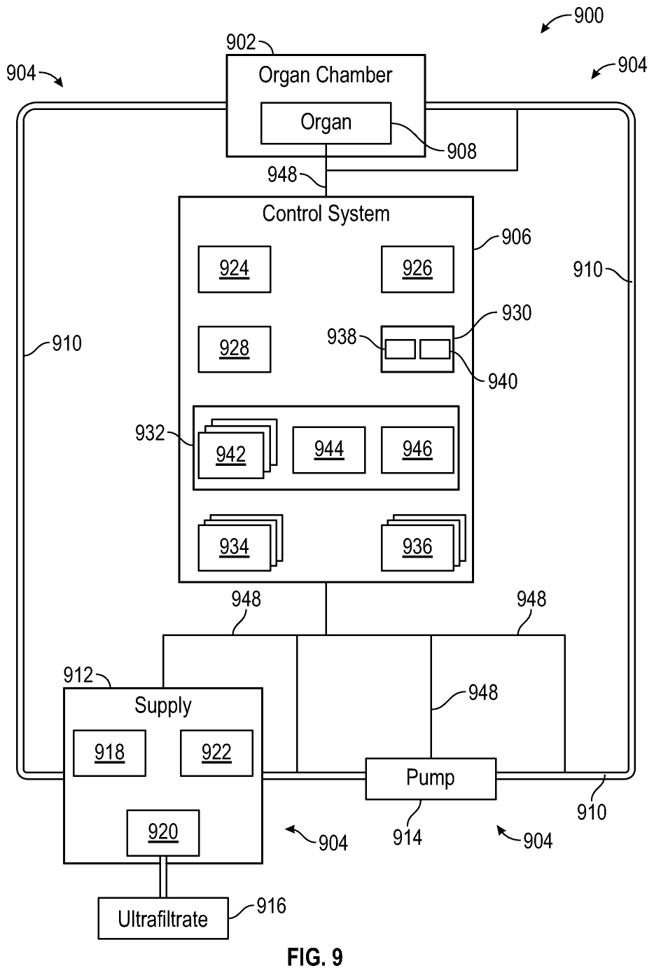

FIG. 9 illustrates an exemplary system 900 for perfusing an organ, according to one embodiment. The system 900 includes an organ chamber 902, a fluid circuit 904, and a control system 906. The organ chamber 902 houses an organ 908. In one embodiment, the organ chamber 902 may be similar to the organ chamber 110 of system 100.

The fluid circuit 904 includes tubing 910, a perfusate supply 912, and a pump 914. In one embodiment, the tubing 910 is similar to the tubing 122 of system 100. The tubing 910 couples to the organ 908 within the organ chamber 902 and carries a perfusate (e.g., perfusate 124) to and from the organ 908. The tubing 910 enables the circulation of perfusate within the fluid circuit 904. The pump 914 is coupled to the tubing 910 and drives the perfusate through the tubing 910. In certain embodiments, the exemplary system 900 may include an oxygenator and/or a heat exchanger.

The perfusate supply 912 is coupled to the tubing 910. In one embodiment, the perfusate supply 912 provides a continuous quantity of perfusate to the fluid circuit 904. In one embodiment, the perfusate supply 912 provides a refreshed quantity of perfusate to the fluid circuit 904. In one embodiment, the perfusate supply 912 provides a continuous and refreshed quantity of perfusate to the fluid circuit 904.

In one embodiment, the perfusate supply 912 provides a continuous supply of perfusate by including diversion systems, subsystems, diverters, diversion valves, and the that introduce perfusate in a manner that does not interfere with perfusion of the organ 908. For example, the perfusate supply 912 provides perfusate in a manner that does not require stopping or interrupting circulation of perfusate in the fluid circuit 904. Alternatively, or in addition, perfusate supply 912 provides perfusate to the fluid circuit 904 during natural breaks and/or relaxation phases of perfusion of the organ 908. For example, where the pump 914 is a peristaltic pump (e.g., pulsatile pump), the perfusate supply 912 may supply perfusate during a relaxation cycle of the pump 914.

In one embodiment, the perfusate supply 912 provides a refreshed quantity of perfusate by modifying/processing perfusate currently in the fluid circuit 904 and/or by introducing perfusate to the fluid circuit 904 that was not already in the fluid circuit 904 (e.g., new perfusate or different perfusate). In one embodiment, the perfusate supply 912 is configured to modify and/or process perfusate in the fluid circuit 904 by filtering and/or applying hemofiltration to the perfusate which produces ultrafiltrate 916. In one embodiment, the perfusate supply 912 is configured to introducing perfusate to the fluid circuit 904 that was not already in the fluid circuit 904 by enabling a bulk perfusate exchange to the fluid circuit 904. This bulk perfusate exchange removes metabolic waste and can remove other contaminants and/or toxins in the perfusate. Alternatively, or in addition, the bulk perfusate exchange can introduce nutrients or drugs to the fluid circuit 904 by way of the added perfusate.

In certain embodiments, the perfusate supply 912 can enable the addition of drugs, nutrients, and/or conditioners (referred to collectively herein as “additives”) to the perfusate 124. In one embodiment, these additives can be included as part of perfusate 124 provided in a bulk exchange. Alternatively, or in addition, the perfusate supply 912 and/or system 900 can include access ports for providing additives by infusion and/or in a bolus.

In the illustrated embodiment, the perfusate supply 912 includes a perfusate filtration system 918, a perfusate hemofiltration system 920, and a perfusate supply system 922. The perfusate filtration system 918 filters perfusate of the fluid circuit 904 for contaminants. The apparatus 700 is one example of a perfusate filtration system 918 that can be used with the perfusate supply 912. Of course, other filtration systems can be used as well within the scope of the present disclosure. Advantageously, the perfusate filtration system 918 performs the filtration without interrupting perfusion.

The perfusate hemofiltration system 920 performs hemofiltration on the perfusate a produces ultrafiltrate 916 that includes metabolic waste from the perfusate. In certain embodiments, the perfusate hemofiltration system 920 includes a replacement fluid supply that provides filtrate replacement fluid 160 as needed to account for ultrafiltrate 916 that is removed. The hemofilter 140 and replacement fluid supply 186 is one example of components for a perfusate hemofiltration system 920 that can be used with the perfusate supply 912. Of course, other hemofiltration systems can be used as well within the scope of the present disclosure. Advantageously, the perfusate hemofiltration system 920 performs the hemofiltration without interrupting perfusion.

In one embodiment, the perfusate supply system 922 replaces one quantity of perfusate in the fluid circuit 904 with a second quantity of perfusate in a single operation. In certain embodiments, the second quantity of perfusate can include one or more additives. (e.g., drugs, nutrients, etc.) The system 600 is one example of a perfusate supply system 922 that can be used with the perfusate supply 912. Of course, other perfusate replacement or exchange systems can be used as well within the scope of the present disclosure. Advantageously, the perfusate supply system 922 performs the exchange or replacement without interrupting perfusion.

In this example, using the perfusate filtration system 918, the perfusate hemofiltration system 920, and/or the perfusate supply system 922 the perfusate supply 912 can refresh perfusate of the fluid circuit 904 effectively, efficiently, and, in certain embodiments, automatically such that viability of the organ 908 is maintained for up to forty-eight hours.

In the illustrated embodiment, the control system 906 adjusts at least one perfusion parameter for the fluid circuit 904 in response to a characteristic of one of the fluid circuit 904 and/or the organ 908. The control system 906 can include a controller 924, a memory 926, a communication interface 928, an I/O interface 930, storage 932, a plurality of sensors 934, and a plurality of actuators 936.

The controller 924 executes executable code and/or program code and accesses data to manage perfusion of the organ 908. Controller 180 of system 100 is one example of a controller 924 that can be used in the control system 906.

In some examples, the fluid circuit 904 utilizes the memory 926 to access program code and/or data. The memory 926 may include volatile and/or nonvolatile memory and may include memory that may be coupled or decoupled to the control system 906 such as a microSD card solid-state drive, or similar storage device. In various examples, the control system 906 may access memory 926 that is virtual memory stored in a storage area network, a remote server, cloud-based data storage, or other discrete or distributed network storage devices.

In various examples, the control system 906 includes a communication interface 928. The communication interface 928 may include hardware circuits and/or software (e.g., drivers, modem, protocol/network stacks) to support wired or wireless communication between the control system 906 and another device or network. The wireless connection may include a mobile telephone network. The wireless connection may also employ a Wi-Fi network based on any one of the Institute of Electrical and Electronics Engineers (IEEE) 802.11 standards. Alternatively, the wireless connection may be a Bluetooth® connection. In addition, the wireless connection may employ a Radio Frequency Identification (RFID) communication including RFID standards established by the International Organization for Standardization (ISO), the International Electrotechnical Commission (IEC), the American Society for Testing and Materials® (ASTM®), the DASH7™ Alliance, and EPCGlobal™. The wireless connection may be an infrared connection including connections conforming at least to the Infrared Physical Layer Specification (IrPHY) as defined by the Infrared Data Association® (IrDA®). Alternatively, the wireless connection may be a cellular telephone network communication. All standards and/or connection types include the latest version and revision of the standard and/or connection type as of the filing date of this application. In one embodiment, the communication interface 928 includes a set of wired connections 948 between sensors 934, actuators 936, and the control system 906. The communication interface 928 is configured to send one or more control signals and receive one or more data signals to and from the plurality of sensors 934 and the plurality of actuators 936 for managing the fluid circuit 904.

In some examples, the control system 906 includes an I/O interface 930 that is configured to communicate with accessories, peripheral devices, input devices, output devices, and so forth. In certain examples, the I/O interface 930 may support various industry standards, such as for example, universal serial bus (USB), USB 2.0, USB 3.0, USB3Vision®, USB 3.1, USB 3.2, FireWire®, HMDI, CameraLink, GigE, CAN Bus, RS232 bus, RS485 bus, spi bus, and so forth which may be used to communicate with devices, peripherals, accessories, and so forth. The foregoing lists of interfaces with a wired or wireless is not intended to be an exhaustive list of the interfaces that may be used in implementing the control system 906 and is intended to show that certain interfaces can be used advantageously to implement the control system 906.

The I/O interface 930 may include or be in communication with a display device 938 and an input device 940. The display device 938 may include any device (e.g., screens, TVs, touch screens, or monitors, tablet computer displays) configured to present a user interface, such as user interface 194 to a user 196 or operator of the control system 906. The input device 940 may include any device (e.g., touch screens, keypads, keyboards, tablet computer displays, voice recognition device, gesture recognition device, etc.) configured to accept and/or interpret user input.

The storage 932 may include one or more non-volatile storage devices that can store data for the control system 906. For example, the storage 932 may store control system parameters 942 perfusion protocols 944, perfusion parameters 946, performance data, physiological statistics, organ profile data, user profile data, user preference data, and the like. “Non-volatile storage device” refers to any hardware, device, component, element, or circuit configured to maintain an alterable physical characteristic (deleted) used to represent a binary value of zero or one after a primary power source is removed. Non-volatile storage media may be used interchangeably herein with the term non-volatile memory media.

In one embodiment, the perfusion protocol 944 is predefined and defines how the system 900 is to be operated for perfusion of the organ 908. In one embodiment, the perfusion protocol 944 is specific to a particular organ 908 being perfused. Those of skill in the art will appreciate that the organ can be any organ or body part of an animal or human including but not limited to a heart, a liver, a kidney, a brain, a lung, a stomach, a pancreas, an intestine, an arm, a hand, a leg, a foot, skin, and the like.

In various examples, the sensors 934 gather information about the system 900. In the illustrated embodiment, the plurality of sensors 934 detect one or more attributes regarding one or more aspects of the fluid circuit 904. Alternatively, or in addition, the plurality of sensors 934 can also detect an attribute regarding an aspect of the organ 908 (e.g., EKG readings or other vitals). In one embodiment, weight sensors may be used with the perfusate supply system 922 to manage perfusate use, with the perfusate hemofiltration system 920 to manage waste removal and/or perfusate introduction and/or replacement, or the like.

In certain embodiments, a single sensor may detect, sense, and/or measure a single attribute, feature, or characteristic. In other embodiments, a single sensor may detect, sense, and/or measure a plurality of attributes, features, and/or characteristics. A sensor can be made up of analog, digital, electrical, mechanical, and/or electromechanical components and may function with or without an external power source. A sensor can employ a variety of technologies in order to detect, sense, and/or measure an attribute, feature, or characteristic. For example, certain sensors may use electronic signals, radio signals, electromagnetic signals, magnetic signals, light signals, sound signals, electrochemical signals, piezoelectric signals, ultrasonic signals and the like. Certain sensors may include a receiver and/or a transmitter of signals or waves for performing the sensing feature. Often a sensor is configured to communicate information about a detected, sensed, and/or measured an attribute, feature, or characteristic to another electronic component or device. The information may be communicated using a wired connection or a wireless connection. The control system 906 may include one or more sensors 934. Or the control system 906 may use the communication interface 928 to communicate with one or more sensors separate from the control system 906.

The plurality of actuators 936 serve to implement one or more changes and/or adjustments to operation of the system 900. The changes or adjustments may be indicated based on or by one or more control signals from components (e.g., a plurality of sensors 934) of the system 900. In certain embodiments, the plurality of actuators 936 may open or close a valve partially or completely, turn on or off a motor, increase or decrease the revolutions per minute of a motor, activate or deactivate a subcircuit of the fluid circuit 904, and the like.

Advantageously, the control system 906 enables a robust, efficient, and effective perfusion process to be conducted on one or more organs 908. The control system 906 manages a plurality of control loops for different aspects of the control system 906. In one embodiment, each of the control loops can be operated in either a manual operation mode or an automated operation mode. Furthermore, an operator can selectively determine which control loops to operate in a manual operation mode or an automated operation mode.

In one embodiment, the control system 906 includes a set of control system parameters 942 that are used to manage the control system 906. The control system 906 can change one or more values for one or more of the control system parameters 942 automatically in response to a passage of time or the occurrence of a specific trigger or event. In one embodiment, control system 906 can change one or more values for one or more of the control system parameters 942 in response user input from a user 196 (e.g., operator).

In the illustrated embodiment, the control system 906 manages operation of the perfusate supply 912. For example, the control system 906 may (using its plurality of sensors 934) monitor the fluid circuit 904. This monitoring provides the control system 906 with a characteristic for the perfusion process. In one example, the characteristic may be an increase in lactate levels for the organ 908. In one embodiment, if the characteristic satisfies a threshold, such as a lactate level that exceeds the threshold, the control system 906 can respond by increasing a rate of removing metabolic wastes from the perfusate. This can be done for example by signaling/directing the perfusate hemofiltration system 920 to remove ultrafiltrate 916 at a higher rate. In another example the characteristic may be a rising coronary artery flow resistance for the organ 908. In one embodiment, if the characteristic satisfies a threshold, such as a flow resistance level that exceeds the threshold, the control system 906 can respond by increasing a rate of drug infusion or bolus into the perfusate.

Of course, if the control system 906 determines based on a characteristic, that more nutrients or a higher quality of perfusate is needed, the control system 906 can direct the perfusate filtration system 918 to increase filtration by bringing another filter into the fluid circuit 904 or the control system 906 can direct the perfusate supply system 922 to infuse more clean or new or reconditioned or processed perfusate into the fluid circuit 904. In this manner, the control system 906 can increase the viability of an organ 908 being perfused. The control system 906 can also mitigate damage to the organ 908 being perfused, for example from ischemia in the context of a heart organ.

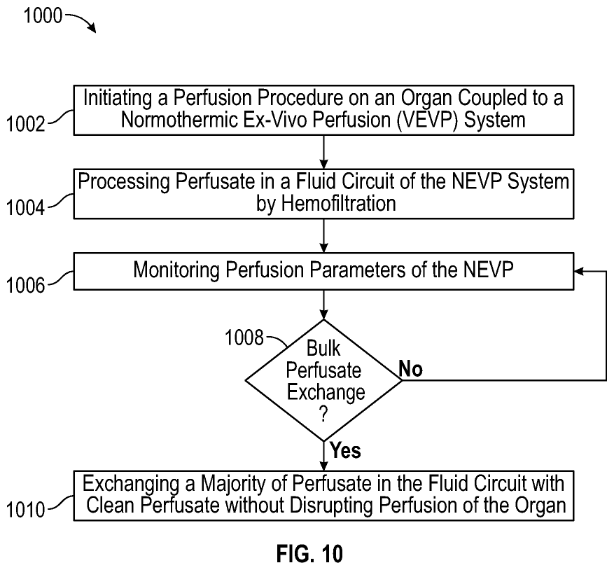

FIG. 10 is a flowchart of an example method 1000 or process 1000 for perfusion, according to one embodiment. In some implementations, one or more process blocks of FIG. 10 may be performed by an apparatus, device or system. Those of skill in the art will appreciate that the example method 1000 can be implemented using any of the apparatuses and/or systems disclosed herein as well as any apparatus or system within the scope of the present disclosure. In one embodiment, the example method 1000 can be implemented using the system 100, system 800, or system 900.

As shown in FIG. 10, example method 1000 may begin with initiating (step 1002) a perfusion procedure on an organ (e.g., a heart) coupled to a normothermic ex-vivo perfusion (NEVP) system (e.g., system 100, system 800, system 900, or the like). In one embodiment, the NEVP system is processing (step 1004) perfusate in a fluid circuit of the NEVP using hemofiltration (e.g., hemofilter 140). This processing provides clean, revitalized, or refreshed, perfusate to the fluid circuit. In one embodiment, this processing can provide new perfusate to the fluid circuit. Next, monitoring (step 1006) of perfusion parameters of the NEVP system can be done by a controller or control system or by an operator or by a combination of these cooperating.

During the perfusion procedure a condition (step 1008) can be checked. The condition may be a determination as to whether or not the perfusate of the fluid circuit should be exchanged. If not, the method 1000 may return to monitoring 1006. If so, the method 1000 proceeds with exchanging (step 1010) a majority of perfusate (e.g., 25% of circuit quantity) in the fluid circuit with clean perfusate. Advantageously, this exchanging step is performed without disrupting perfusion of the organ.

In one embodiment, the example method 1000 can include initiating one or more control loops in a manual mode of operation. The manual operation mode may be managed, monitored, and/or controlled by an operator. Once an operator is satisfied with perfusion performance of a control loop under manual operation mode, the operator may signal to a NEVP system that the control loop can now be managed by the NEVP system under an automated operation mode. An operator can then repeat this process until most or all control loops of the NEVP are transitioned from manual operation mode to automated operation mode.

Those of skill in the art will appreciate that embodiments of the apparatuses, systems, and/or methods disclosed herein can be used with organs or body parts from humans or animals. Advantageously, the embodiments of the apparatuses and systems manage perfusate quality, composition, quantity, and/or waste removal in a manner that mitigates, reduces, or eliminates interruptions of a perfusion process and extends the viability of a perfused organ. Consequently, use of NEVP systems, apparatuses, and/or methods in accordance with the present disclosure enables long term (e.g., two or more days) perfusion of organs which greatly improves transplantation options, research, and/or treatment options for both patients and the medical industry.

Advantageously, the embodiments of the present disclosure manage one or more of the control loops of a perfusion system in an automated operation mode. This offloads the responsibilities of an operator for managing and operating the perfusion apparatus, system, and/or method.

Embodiments of the present disclosure reliably and automatically adjusts to changes in the conditions of the perfusion to maintain long term viability of the perfused organ, tissue, and/or body part. Embodiments of the present disclosure enables reliable and consistent providing of perfusate conditioned (e.g., filtered, cleaned, supplemented, enhanced, nutrient fortified, hemofiltration treated, new, and/or bulk exchanged) for long term perfusion of the perfused organ, tissue, and/or body part. Embodiments of the present disclosure enable reliable and consistent providing of perfusate conditioned for long term perfusion of the perfused organ, tissue, and/or body part without disrupting the perfusion.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles set forth herein.

While specific embodiments and applications of the present disclosure have been illustrated and described, it is to be understood that the scope of this disclosure is not limited to the precise configuration and components disclosed herein. Various modifications, changes, and variations which will be apparent to those skilled in the art may be made in the arrangement, operation, and details of the methods and systems of the present disclosure set forth herein without departing from it spirit and scope.

1. A system for perfusion of an organ, the system comprising:
an organ chamber configured to house an organ;
a fluid circuit comprising:
tubing that couples to the organ within the organ chamber and carries a perfusate to and from the organ;
a pump coupled to the tubing, the pump configured to drive the perfusate through the fluid circuit;
a replaceable reservoir that supplies perfusate to the tubing for use in the fluid circuit;
an oxygenator coupled to the tubing and configured to exchange oxygen gas with waste gas in the perfusate;
a hemofilter coupled to the tubing and configured to remove an ultrafiltrate comprising metabolic waste from the perfusate;
a filtrate replacement fluid coupled to the fluid circuit and configured to supply filtrate replacement fluid to the perfusate; and
a controller coupled to the fluid circuit, the controller configured to manage a plurality of perfusion parameters of the fluid circuit to perfuse the organ.

2. The system of claim 1, wherein the replaceable reservoir is configured to supply clean perfusate without interrupting perfusion of the organ.

3. The system of claim 1, wherein the replaceable reservoir comprises a first filter, a second filter, and a diverter that when activated redirects at least a portion of the perfusate from the first filter to the second filter.

4. The system of claim 1, wherein the replaceable reservoir comprises:
a first supply reservoir configured to be coupled to the fluid circuit;
a second supply reservoir configured to be coupled to the fluid circuit; and
a bulk perfusate diversion system configured to exchange perfusate in the first supply reservoir with perfusate in the second supply reservoir for a bulk removal of metabolic waste in the perfusate.

5. The system of claim 1, further comprising:
a user interface configured to display information to an operator and accept input data from the operator for perfusion parameters for manual operation mode of at least one control loop of a plurality of control loops of the system; and
wherein the controller is configured to transition the at least one control loop from manual operation mode to automated operation mode in response to user input from the operator.

6. The system of claim 5, wherein the controller is configured to operate the at least one control loop in automated operation mode while another one of the plurality of control loops operates in manual operation mode.

7. The system of claim 1, wherein the controller modulates the plurality of perfusion parameters of the fluid circuit to perfuse the organ based on a perfusion protocol.

8. The system of claim 7, wherein the organ is a heart and the perfusion protocol includes a perfusion mode selected from the group comprising “Langendorff” perfusion, “Partial Working Mode Perfusion”, “Left Atrial Perfusion”, and working mode perfusion.

9. The system of claim 1, wherein the controller modulates a rate of at least one of filtrate replacement fluid supplied to the perfusate and ultrafiltrate removal based on a measured parameter of at least one of the organ and the fluid circuit.

10. A system for perfusion of an organ, the system comprising:
an organ chamber configured to house an organ;
an extracorporeal fluid circuit comprising:
tubing that couples to the organ within the organ chamber and carries a perfusate to and from the organ;
a pump that drives the perfusate through the extracorporeal fluid circuit;
an oxygenator coupled to the tubing and configured to exchange oxygen gas with waste gas in the perfusate;
perfusate supply that supplies revitalized perfusate to the extracorporeal fluid circuit by way of the tubing; and
a controller coupled to the extracorporeal fluid circuit, the controller configured to manage a plurality of perfusion parameters of the extracorporeal fluid circuit to perfuse the organ.

11. The system of claim 10, wherein the perfusate supply comprises:
at least one inlet port coupled to the tubing;
a filter diversion system coupled to the at least one inlet port in fluid communication with the tubing;
a first blood filter coupled to the filter diversion system by way of a first filter cap, the first blood filter comprising a first replaceable filter media;
a second blood filter coupled to the filter diversion system by way of a second filter cap, the second blood filter comprising a second replaceable filter media; and
wherein activation of the filter diversion system diverts the perfusate from the first blood filter to the second blood filter such that replacement of the first replaceable filter media does not interrupt filtration of the perfusate.

12. The system of claim 11, wherein the filter diversion system comprises a filter diverter configured to operate as at least one of a sequential diversion system and parallel diversion system between the first blood filter and the second blood filter.

13. The system of claim 10, wherein the perfusate supply comprises:
a first reservoir comprising a first reservoir inlet port and a first reservoir outlet port;
a second reservoir comprising a second reservoir inlet port and a second reservoir outlet port; and
a flow diversion system in fluid communication with the first reservoir, the second reservoir, and the tubing.

14. The system of claim 13 wherein the flow diversion system comprises:
an inlet diverter in fluid communication with the tubing, with the first reservoir inlet port and with the second reservoir inlet port, the inlet diverter configured to direct the perfusate into the first reservoir;
an outlet diverter in fluid communication with the first reservoir outlet port, the second reservoir outlet port, and the tubing, the outlet diverter configured to direct the perfusate from the first reservoir into the extracorporeal fluid circuit; and
wherein activation of the inlet diverter redirects the perfusate from the first reservoir inlet port to the second reservoir inlet port and activation of the outlet diverter redirects the perfusate from the first reservoir outlet port to the second reservoir outlet port such that perfusate of the first reservoir is exchanged in the extracorporeal fluid circuit with the perfusate of the second reservoir.

15. A system for perfusion of an organ, the system comprising:
an organ chamber configured to house an organ;
a fluid circuit comprising:
tubing that couples to the organ within the organ chamber and carries a perfusate to and from the organ;
a perfusate supply coupled to the tubing, the perfusate supply configured to provide continuously refreshed perfusate to the fluid circuit;
a pump coupled to the tubing, the pump configured to drive the perfusate through the fluid circuit; and
a control system coupled to the fluid circuit, the control system configured to adjust at least one perfusion parameter for the fluid circuit in response to a characteristic of one of the fluid circuit and the organ, control system comprising:
a controller configured to execute executable code to manage perfusion of the organ;
a memory comprising code executable by the controller to manage perfusion of the organ;
a communication interface configured to send one or more control signals and receive one or more data signals for managing the fluid circuit;
an I/O interface configured to interact with an operator;
storage configured to store at least one perfusion protocol predefined for perfusion of the organ;
a plurality of sensors configured to detect an attribute regarding at least one aspect of the fluid circuit or the organ; and
a plurality of actuators configured to implement a change indicated by the one or more control signals.

16. The system of claim 15, wherein the control system comprises a set of control system parameters and the controller is configured to change at least one value for the set of control system parameters in response to user input.

17. The system of claim 15, wherein the at least one perfusion protocol is specific to the organ perfused by the system and the organ is selected from the group comprising of a heart, a liver, a kidney, a brain, a lung, a stomach, pancreas, an intestine, an arm, a hand, a leg, a foot, and skin.

18. The system of claim 15, wherein the organ chamber is configured to house a plurality of organs, the fluid circuit couples to the plurality of organs and the control system adjusts the at least one perfusion parameter in response to a characteristic of one of the fluid circuit and the plurality of organs.

19. The system of claim 15, wherein the control system monitors the fluid circuit and directs the perfusate supply to increase a rate of removing metabolic waste from the perfusate in response to a characteristic satisfying a threshold.

20. The system of claim 15, wherein the perfusate supply comprises:
a perfusate filtration system;
a perfusate hemofiltration system; and
a perfusate supply exchange system; and
wherein the perfusate filtration system, perfusate hemofiltration system, and perfusate supply exchange system are each configured to refresh perfusate without interrupting perfusion of the organ.
